(19) United States
(12) Patent Application Publication
(10) Pub. No.: US 2023/0330724 A1
(43) Pub. Date: Oct. 19, 2023

(54) SYSTEMS AND METHODS FOR PROCESSING ASH

(71) Applicants: Massachusetts Institute of Technology, Cambridge, MA (US); Carnegie Mellon University, Pittsburgh, PA (US)

(72) Inventors: Yet-Ming Chiang, Weston, MA (US); Leah Ellis, Hammonds Plains (CA); Sophie C. Coppieters 't Wallant, Kenilworth, IL (US); Sonia Zhang, Cambridge, MA (US); Venkatasubramanian Viswanathan, Pittsburgh, PA (US); Elsa A. Olivetti, Arlington, MA (US); Michael Joseph Wang, Cambridge, MA (US)

(73) Assignees: Massachusetts Institute of Technology, Cambridge, MA (US); Carnegie Mellon University, Pittsburgh, PA (US)

(21) Appl. No.: 18/017,114

(22) PCT Filed: Jul. 21, 2021
(86) PCT No.: PCT/US21/42573

§ 371 Date: Jan. 20, 2023

Related U.S. Application Data
(60) Provisional application No. 63/054,703, filed on Jul. 21, 2020.

(51) Int. Cl. B09B 3/70; C25D 17/12; C25D 3/46; C25D 3/48; C25D 3/50; C25D 5/48

(52) U.S. Cl. CPC B09B 3/70; C25D 17/12; C25D 3/46; C25D 3/48; C25D 3/50; C25D 5/48; B09B 2101/30

(57) ABSTRACT

Disclosed herein are systems and methods for processing ash. For example, in certain embodiments, the method comprises dissolving at least a portion of ash in acid. In some embodiments, the acid is produced in a reactor. In some embodiments, dissolving at least a portion of ash in acid produces refined silica (SiO₂) (e.g., amorphous silica, substantially pure silica, and/or a substantial amount of silica). According to certain embodiments, the ash can be further processed (e.g., using electro winning, pH-based precipitation, and/or electrorefining) to obtain other components instead of or in addition to refined silica.

### RELATED APPLICATIONS

This application is a national stage filing under 35 U.S.C. § 371 of International Patent Application No. PCT/US2021/042573, filed Jul. 21, 2021, which claims priority under 35 U.S.C. § 119(e) to U.S. Provisional Patent Application No. 63/054,703, filed Jul. 21, 2020, each of which is hereby incorporated by reference in its entirety.

### GOVERNMENT SPONSORSHIP

This invention was made with government support under DE-AR0001395 awarded by the U.S. Department of Energy. The government has certain rights in the invention.

### TECHNICAL FIELD

Methods for processing ash, and related systems, are generally described.

### SUMMARY

Disclosed herein are systems and methods for processing ash. For example, in certain embodiments, the method comprises dissolving at least a portion of ash in acid. In some embodiments, the acid is produced in a reactor. In some embodiments, dissolving at least a portion of the ash in acid produces refined silica (SiO₂) (e.g., amorphous silica, substantially pure silica, and/or a substantial amount of silica). According to certain embodiments, the ash can be further processed (e.g., using electrowinning, pH-based precipitation, and/or electrorefining) to obtain other components instead of or in addition to refined silica. For example, in some cases, dissolving at least a portion of the ash in acid produces refined silica and an acid leachate, and the acid leachate may be electrowon to obtain other components (e.g., electroplated metals), which may, optionally, be further separated by electrorefining. Similarly, in certain instances, electrowinning the acid leachate further produces an aqueous solution, and adding a base to the aqueous solution may precipitate other components (e.g., one or more metal hydroxides). Still further, in addition to or as an alternative to electrowinning the acid leachate, in some embodiments, base may be added to the refined silica to form a basic solution and a solid, acid may be added to the basic solution to form an acidic solution, and the acidic solution may be electrowon to obtain other components (e.g., electroplated noble metals). In certain embodiments, the base is produced in a reactor.

Certain aspects relate to methods. In some embodiments, the method comprises dissolving at least a portion of ash in acid to produce refined silica with a purity of greater than or equal to 60 wt. %.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### BRIEF DESCRIPTION OF THE DRAWINGS

Non-limiting embodiments of the present invention will be described by way of example with reference to the accompanying figures, some of which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic illustration of a method of processing ash, in accordance with certain embodiments.

FIG. 2 is a flow chart of a process, in accordance with certain embodiments.

FIG. 3A shows the elements in municipal solid waste incinerator (MSWI) bottom ash (BA) ranked by abundance for various sources. Not all sources were analyzed for all elements. The number of elements (N) analyzed per source is noted in the legend. FIG. 3B shows the corresponding cumulative value of elements in 1 kg of BA, ranked by value (abundance×price).

FIG. 4A shows electrolytic productions of acid and base. FIG. 4B shows reactions for dissolution of CaCO₃ and precipitation of Ca(OH)₂.

FIG. 5A shows precipitated product from lab-scale reactor. FIG. 5B is an XRD that showed that the precipitated product from FIG. 5A is Ca(OH)₂. FIG. 5C shows one precipitate morphology and size scale for the produced Ca(OH)₂ while FIG. 5D shows another. FIG. 5E shows the starting natural limestone, the impurities removed, and the ending pure hydrated lime.

FIG. 6 plots various elements (x-axis) versus the pH at which elemental solubility is 0.1 mol/L (left y-axis, and dark gray circles) (open symbols were approximated from solubility constants of similar elements) and the reduction potential (right y-axis, light gray circles) adjusted for relative concentration. Below the horizontal line, electrochemical water splitting is favored.

FIG. 7 shows a flow chart for a process for separating components of MSWI ash using acid, base, and electricity streams, according to certain embodiments.

FIG. 8 shows the composition analysis of various fractions of ash using inductively-coupled plasma emission (ICP) spectroscopy.

FIG. 9 is a representative energy-dispersive X-ray detector (EDS) spectrum of the insoluble portion when ash was leached with acid.

FIG. 10 is an X-ray diffraction (XRD) pattern of the insoluble portion when ash was leached with acid.

FIG. 11 is a photograph of the precipitates obtained through sequential precipitation on acid leachate at pH values of 4, 5, 7, 13, and 14.

FIG. 12 is a representative SEM image of a metal deposit recovered by electrowinning at −0.75V vs an Ag/AgCl reference electrode.

FIG. 13 is a non-limiting example of a suitable order-of-operations for recovery of elements from ash in accordance with certain embodiments.

### DETAILED DESCRIPTION

Disclosed herein are systems and methods for processing ash. For example, in certain embodiments, the method comprises dissolving at least a portion of ash in acid. In some embodiments, the acid is produced in a reactor. In some embodiments, dissolving at least a portion of the ash in acid produces refined silica (SiO₂) (e.g., amorphous silica, substantially pure silica, and/or a substantial amount of silica). According to certain embodiments, the ash can be further processed (e.g., using electrowinning, pH-based precipitation, and/or electrorefining) to obtain other components instead of or in addition to refined silica. For example, in some cases, dissolving at least a portion of ash in acid produces refined silica and an acid leachate, and the acid leachate may be electrowon to obtain other components (e.g., electroplated metals), which may, optionally, be further separated (e.g., by electrorefining). Similarly, in certain instances, electrowinning the acid leachate further produces an aqueous solution, and adding a base to the aqueous solution may precipitate other components (e.g., one or more metal hydroxides). Still further, in addition to or as an alternative to electrowinning the acid leachate, in some embodiments, base may be added to the refined silica to form a basic solution and a solid, acid may be added to the basic solution to form an acidic solution, and the acidic solution may be electrowon to obtain other components (e.g., electroplated noble metals). In certain embodiments, the base is produced in a reactor.

Certain aspects are related to methods.

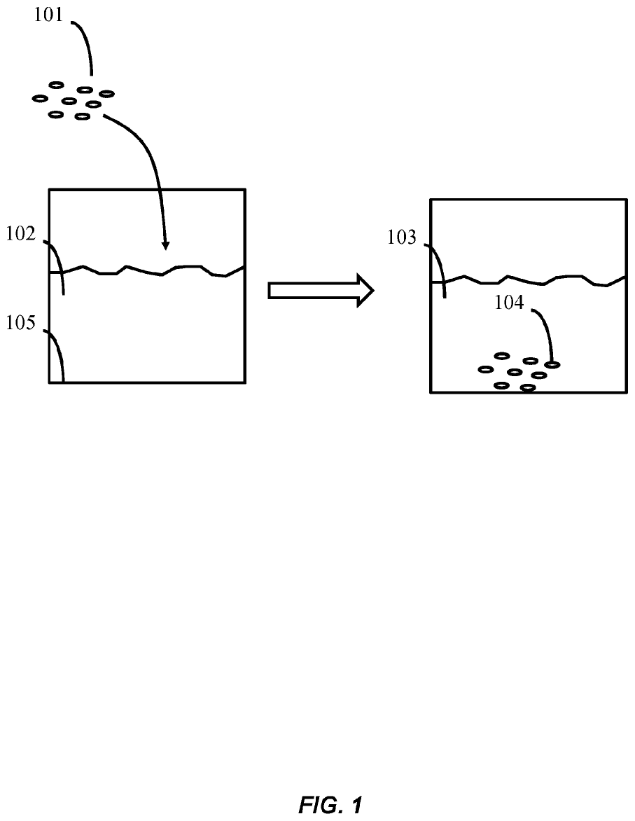

In some embodiments, the method comprises dissolving at least a portion of ash in acid to produce refined silica (SiO₂). The term “refined silica” is generally used herein to refer to a material that has a higher mass percentage of silica (SiO₂) than was present in the ash from which the silica was refined (e.g., ash). For example, in FIG. 1, in some cases, the method comprises dissolving at least a portion of ash 101 in acid 102 to produce refined silica 104. In certain embodiments, dissolving at least a portion of a substance (e.g., ash) comprises dissolving at least a portion of a solid (e.g., ash) (e.g., at least 25 wt. %, at least 50 wt. %, at least 75 wt. %, at least 90 wt. %, or all of the solid) to form at least one or more solubilized components (e.g., one or more ions, elements, and/or compounds). In certain instances, dissolving at least a portion of ash comprises forming certain solubilized components (e.g., certain metals) while some components of the ash remain in solid form (e.g., silica, or a portion of the silica). In certain embodiments, dissolving at least a portion of ash comprises forming solubilized components from at least 25 wt. %, at least 50 wt. %, at least 75 wt. %, at least 90 wt. %, or all of the ash components that are not silica (also referred to herein as non-silica ash components). In some cases, a solid disclosed herein comprises a crystalline solid, an amorphous solid, a nanocrystalline solid, and/or a mixture thereof.

In certain embodiments, the ash comprises municipal solid waste incinerator (MSWI) ash, bottom ash, and/or fly ash from a combustion process (e.g., from a coal-burning power plant). In some embodiments, the ash comprises greater than or equal to 3 (e.g., greater than or equal to 4, or 5) of the following 5 elements: Si, Ca, Fe, Al, and Na. In certain embodiments, the ash comprises greater than or equal to 3 (e.g., greater than or equal to 4, or 5) of the 5 elements (Si, Ca, Fe, Al, and Na) each in an amount of greater than or equal to 0.01 wt. %, greater than or equal to 0.1 wt. %, or greater than or equal to 1 wt. %. According to some embodiments, the ash comprises greater than or equal to 3 (e.g., greater than or equal to 4, or 5) of the 5 elements (Si, Ca, Fe, Al, and Na) each in an amount of less than or equal to 50 wt. %, less than or equal to 40 wt. %, less than or equal to 30 wt. %, less than or equal to 20 wt. %, less than or equal to 10 wt. %, or less than or equal to 5 wt. %. Combinations of these ranges are also possible (e.g., greater than or equal to 0.01 wt. % and less than or equal to 50 wt. %, greater than or equal to 0.1 wt. % and less than or equal to 40 wt. %, or greater than or equal to 1 wt. % and less than or equal to 40 wt. %).

In certain embodiments, the ash comprises greater than or equal to 0.1 wt. % Si, greater than or equal to 1 wt. % Si, greater than or equal to 2 wt. % Si, greater than or equal to 5 wt. % Si, greater than or equal to 10 wt. % Si, or greater than or equal to 20 wt. % Si. According to some embodiments, the ash comprises less than or equal to 50 wt. % Si, less than or equal to 40 wt. % Si, less than or equal to 30 wt. % Si, less than or equal to 20 wt. % Si, or less than or equal to 10 wt. % Si. Combinations of these ranges are also possible (e.g., greater than or equal to 0.1 wt. % and less than or equal to 50 wt. % Si, greater than or equal to 5 wt. % and less than or equal to 50 wt. % Si, or greater than or equal to 20 wt. % and less than or equal to 40 wt. % Si).

In certain embodiments, the ash comprises greater than or equal to 0.01 wt. % Ca, greater than or equal to 0.1 wt. % Ca, greater than or equal to 1 wt. % Ca, greater than or equal to 5 wt. % Ca, or greater than or equal to 10 wt. % Ca. According to some embodiments, the ash comprises less than or equal to 50 wt. % Ca, less than or equal to 40 wt. % Ca, less than or equal to 30 wt. % Ca, less than or equal to 20 wt. % Ca, less than or equal to 10 wt. % Ca, or less than or equal to 5 wt. % Ca. Combinations of these ranges are also possible (e.g., greater than or equal to 0.01 wt. % and less than or equal to 50 wt. % Ca, greater than or equal to 5 wt. % and less than or equal to 40 wt. % Ca, or greater than or equal to 10 wt. % and less than or equal to 30 wt. % Ca).

In certain embodiments, the ash comprises greater than or equal to 0.01 wt. % Fe, greater than or equal to 0.1 wt. % Fe, greater than or equal to 1 wt. % Fe, or greater than or equal to 2 wt. % Fe. According to some embodiments, the ash comprises less than or equal to 30 wt. % Fe, less than or equal to 20 wt. % Fe, less than or equal to 10 wt. % Fe, less than or equal to 5 wt. % Fe, or less than or equal to 1 wt. % Fe. Combinations of these ranges are also possible (e.g., greater than or equal to 0.01 wt. % and less than or equal to 30 wt. % Fe, greater than or equal to 1 wt. % and less than or equal to 10 wt. % Fe, or greater than or equal to 2 wt. % to less than or equal to 20 wt. % Fe).

In certain embodiments, the ash comprises greater than or equal to 0.01 wt. % Al, greater than or equal to 0.1 wt. % Al, greater than or equal to 1 wt. % Al, or greater than or equal to 2 wt. % Al. According to some embodiments, the ash comprises less than or equal to 40 wt. % Al, less than or equal to 30 wt. % Al, less than or equal to 20 wt. % Al, less than or equal to 10 wt. % Al, or less than or equal to 5 wt. % Al. Combinations of these ranges are also possible (e.g., greater than or equal to 0.01 wt. % and less than or equal to 40 wt. % Al, greater than or equal to 1 wt. % and less than or equal to 10 wt. % Al, or greater than or equal to 2 wt. % and less than or equal to 30 wt. %).

In certain embodiments, the ash comprises greater than or equal to 0.01 wt. % Na, greater than or equal to 0.1 wt. % Na, greater than or equal to 1 wt. % Na, or greater than or equal to 2 wt. % Na. According to some embodiments, the ash comprises less than or equal to 15 wt. % Na, less than or equal to 10 wt. % Na, or less than or equal to 5 wt. % Na. Combinations of these ranges are also possible (e.g., greater than or equal to 0.01 wt. % and less than or equal to 15 wt. % Na, greater than or equal to 1 wt. % and less than or equal to 5 wt. % Na, or greater than or equal to 2 wt. % and less than or equal to 10 wt. % Na).

In some embodiments, the ash comprises components, such as silicon and/or metals (e.g., alkali metals, alkaline earth metals, metals in Groups 3-13 of the Periodic Table, first-row transition metals, base metals, rare earth metals, platinum group elements, noble elements, and/or post transition metals). Examples of alkali metals include Li, Na, K, Rb and Cs. Examples of alkaline earth metals include Be, Mg, Ca, Sr, and Ba. Examples of first-row transition metals include Ti, V, Cr, Mn, Fe, Co, and Ni. Example of base metals include Cu, Zn, Al, and Sn. Examples of rare earth elements include Ce, Dy, Er, Eu, Gd, Ho, La, Lu, Nd, Pr, Pm, Sm, Sc, Tb, Tm, Yb and Y. Examples of platinum group or noble elements include Ru, Rh, Pd, Re, Os, Ir, Pt, Au and Ag. Examples of post transition metals include Ga, Ge, As, Se, Cd, In, Sb, Te, Tl, Pb, Bi, Po, and Th and U.

In certain cases, the ash comprises a certain concentration of one or more of these components. For example, in some embodiments, the concentration of one or more of these components in the ash is greater than or equal to 0.0001 wt. %, greater than or equal to 0.001 wt. %, greater than or equal to 0.01 wt. %, greater than or equal to 0.1 wt. %, greater than or equal to 1 wt. %, greater than or equal to 3 wt. %, greater than or equal to 5 wt. %, greater than or equal to 10 wt. %, greater than or equal to 15 wt. %, greater than or equal to 20 wt. %, greater than or equal to 25 wt. %, greater than or equal to 30 wt. %, greater than or equal to 35 wt. %, greater than or equal to 40 wt. %, greater than or equal to 50 wt. %, greater than or equal to 60 wt. %, greater than or equal to 70 wt. %, greater than or equal to 80 wt. %, or greater than or equal to 90 wt. % of the total weight of the ash. In certain embodiments, the concentration of one or more of these components in the ash is less than or equal to 99 wt. %, less than or equal to 95 wt. %, less than or equal to 90 wt. %, less than or equal to 80 wt. %, less than or equal to 70 wt. %, less than or equal to 60 wt. %, less than or equal to 50 wt. %, less than or equal to 45 wt. %, less than or equal to 40 wt. %, less than or equal to 35 wt. %, less than or equal to 30 wt. %, less than or equal to 25 wt. %, less than or equal to 20 wt. %, less than or equal to 15 wt. %, less than or equal to 10 wt. %, less than or equal to 5 wt. %, less than or equal to 1 wt. %, less than or equal to 0.5 wt. %, or less than or equal to 0.1 wt. % of the total weight of the ash. Combinations of these ranges are also possible (e.g., greater than or equal to 0.0001 wt. % and less than or equal to 99 wt. %, greater than or equal to 1 wt. % and less than or equal to 99 wt. %, greater than or equal to 1 wt. % and less than or equal to 50 wt. %, greater than or equal to 0.001 wt. % and less than or equal to 5 wt. %, or greater than or equal to 3 wt. % and less than or equal 40 wt. %).

In some embodiments, the acid comprises any acid disclosed herein, such as an acid produced in a reactor. Methods of producing acids in a reactor are described in further detail in U.S. Provisional Patent Application No. 62/793,294, filed Jan. 16, 2019; U.S. Provisional Patent Application No. 62/800,220, filed Feb. 1, 2019; U.S. Provisional Patent Application No. 62/818,604, filed Mar. 14, 2019; U.S. Provisional Patent Application No. 62/887,143, filed Aug. 15, 2019; U.S. Provisional Patent Application No. 62/962,061, filed Jan. 16, 2020; U.S. Provisional Patent Application No. 63/018,696, filed May 1, 2020; U.S. Provisional Patent Application No. 63/054,683, filed Jul. 21, 2020; International Patent Application No. PCT/US2020/013837, filed Jan. 16, 2020, published as WO 2020/150449 on Jul. 23, 2020; International Patent Application No. PCT/US2020/022672, filed Mar. 13, 2020, published as WO 2020/186178 on Sep. 17, 2020; and International Patent Application No. PCT/US2021/029918, filed Apr. 29, 2021; all of which are hereby incorporated by reference in their entireties for all purposes. Examples of suitable acids include HCl, HNO₃, and/or H₂SO₄.

In accordance with certain embodiments, the refined silica is substantially pure. For example, in some embodiments, the refined silica has little to no components other than silica. For example, in some cases, the refined silica has a purity of greater than or equal to 60 wt. %, greater than or equal to 70 wt. %, greater than or equal to 80 wt %., greater than or equal to 90 wt. %, greater than or equal to 95 wt. %, greater than or equal to 98 wt. %, or greater than or equal to 99 wt. %. In certain instances, the refined silica has a purity of less than or equal to 100 wt. %, less than or equal to 99.9 wt. %, less than or equal to 99.5 wt. %, less than or equal to 99 wt. %, less than or equal to 98 wt. %, less than or equal to 95 wt. %, less than or equal to 90 wt. %, or less than or equal to 80 wt. %. Combinations of these ranges are also possible (e.g., greater than or equal to 60 wt. % and less than or equal to 100 wt. %, greater than or equal to 60 wt. % and less than or equal to 99.9 wt. %, greater than or equal to 80 wt. % and less than or equal to 99.9 wt. %, or greater than or equal to 90 wt. % and less than or equal to 99.9 wt. %). The “purity” of refined silica refers to the percentage (by weight) of the refined silica that is SiO₂.

According to certain embodiments, the refined silica is substantially free of toxic impurities. For example, in some instances, the refined silica has less than or equal to 2 wt. % (or less than or equal to 1 wt. %, less than or equal to 0.1 wt. %, less than or equal to 0.01 wt. %, less than or equal to 0.001 wt. %, or less than or equal to 0.0005 wt. %), toxic impurities. In certain cases, the refined silica has greater than or equal to 0.0001 wt. % toxic impurities. Combinations of these ranges are also possible (e.g., greater than or equal to 0.0001 wt. % and less than or equal to 2 wt. % toxic impurities). Examples of toxic impurities include impurities that are not suitable for being disposed in a landfill, such as mercury, lead, cadmium, chromium, and arsenic. In some instances, the refined silica has less than or equal to 2 wt. % (or less than or equal to 1 wt. %, less than or equal to 0.1 wt. %, less than or equal to 0.01 wt. %, less than or equal to 0.001 wt. %, or less than or equal to 0.0005 wt. %, and/or greater than or equal to 0.0001 wt. %) mercury. In some instances, the refined silica has less than or equal to 2 wt. % (or less than or equal to 1 wt. %, less than or equal to 0.1 wt. %, less than or equal to 0.01 wt. %, less than or equal to 0.001 wt. %, or less than or equal to 0.0005 wt. %, and/or greater than or equal to 0.0001 wt. %) lead. In some instances, the refined silica has less than or equal to 2 wt. % (or less than or equal to 1 wt. %, less than or equal to 0.1 wt. %, less than or equal to 0.01 wt. %, less than or equal to 0.001 wt. %, or less than or equal to 0.0005 wt. %, and/or greater than or equal to 0.0001 wt. %) cadmium. In some instances, the refined silica has less than or equal to 2 wt. % (or less than or equal to 1 wt. %, less than or equal to 0.1 wt. %, less than or equal to 0.01 wt. %, less than or equal to 0.001 wt. %, or less than or equal to 0.0005 wt. %, and/or greater than or equal to 0.0001 wt. %) chromium. In some instances, the refined silica has less than or equal to 2 wt. % (or less than or equal to 1 wt. %, less than or equal to 0.1 wt. %, less than or equal to 0.01 wt. %, less than or equal to 0.001 wt. %, or less than or equal to 0.0005 wt. %, and/or greater than or equal to 0.0001 wt. %) arsenic.

According to some embodiments, the method comprises producing a substantial amount of refined silica. For example, in some cases, the method comprises producing greater than or equal to 10 kg, greater than or equal to 100 kg, or greater than or equal to 1,000 kg of refined silica. In certain instances, the method comprises producing less than or equal to 1,000,000 kg, less than or equal to 100,000 kg, less than or equal to 10,000 kg, or less than or equal to 1,000 kg of refined silica. Combinations of these ranges are also possible (e.g., greater than or equal to 10 kg and less than or equal to 100,000 kg, or greater than or equal to 100 kg and less than or equal to 10,000 kg, or greater than or equal to 1,000 kg and less than or equal to 10,000 kg.).

In accordance with some embodiments, the refined silica is solid. For example, in some cases, the refined silica comprises a crystalline solid, an amorphous solid, a nanocrystalline solid, and/or a mixture thereof. In accordance with certain embodiments, the refined silica comprises a substantial amount of amorphous silica. For example, in some embodiments, the refined silica comprises greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, or greater than or equal to 80 wt. % amorphous silica. In certain embodiments, the refined silica comprises less than or equal to 95 wt. %, less than or equal to 90 wt. %, less than or equal to 80 wt. %, less than or equal to 70 wt. %, or less than or equal to 60 wt. % amorphous silica. Combination of these ranges are also possible (e.g., greater than or equal to 10 wt. % and less than or equal to 95 wt. %, greater than or equal to 20 wt. % and less than or equal to 80 wt. %, greater than or equal to 30 wt. % and less than or equal to 70 wt. %, greater than or equal to 40 wt. % and less than or equal to 60 wt. %, greater than or equal to 80 wt. % and less than or equal to 95 wt. %, or greater than or equal to 70 wt. % and less than or equal to 95 wt. %).

In accordance with some embodiments, the method further comprises disposing the refined silica in a landfill; using the refined silica as a component in cement, concrete, and/or other construction materials; using the refined silica to make glass; and/or using the refined silica as a dessicant, as a thickener, and/or as an additive in rubber or plastics.

In some embodiments, the dissolving at least a portion of ash in acid produces the refined silica and an acid leachate. For example, in FIG. 1, in certain instances, the method comprises dissolving at least a portion of ash 101 in acid 102 to produce refined silica 104 and acid leachate 103.

In certain embodiments, the method further comprises at least partially separating the refined silica from the acid leachate (e.g., using centrifugation and/or filtration, such as vacuum filtration and/or gravity filtration). In some embodiments, at least partially separating the refined silica from the acid leachate comprises producing a first separated portion and a second separated portion, wherein the first separated portion has a relatively large percentage (by weight) of the refined silica produced compared to the second separated portion, and the second separated portion has a relatively large percentage (by weight) of the acid leachate produced compared to the first separated portion. For example, in some cases, the first separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of the silica that was present during the dissolving. In some embodiments, the first separated portion comprises 100 wt. % of the silica that was present during the dissolving. In certain instances, the second separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of the acid leachate produced from the dissolving. In some embodiments, the second separated portion comprises 100 wt. % of the acid leachate produced from the dissolving. Combinations of these ranges are also possible (e.g., the first separated portion comprises greater than or equal to 60 wt. % of the silica that was present during the dissolving and the second separated portion comprises greater than or equal to 60 wt. % of the acid leachate produced from the dissolving). For example, in a case where ash comprising 50 grams of silica was at least partially dissolved in acid producing 50 grams of silica and 1,000 grams of acid leachate, if the first separated portion comprises greater than or equal to 30 grams of silica and the second separated portion comprises greater than or equal to 600 grams of acid leachate, then the first separated portion comprises greater than or equal to 60 wt. % of the silica that was present during the dissolving and the second separated portion comprises greater than or equal to 60 wt. % of the acid leachate produced from the dissolving.

In certain embodiments, the first separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % refined silica. In some embodiments, the first separated portion comprises 100 wt. % refined silica. In certain embodiments, the second separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % acid leachate. In some embodiments, the second separated portion comprises 100 wt. % acid leachate. Combinations of these ranges are also possible (e.g., the first separated portion comprises greater than or equal to 60 wt. % refined silica and the second separated portion comprises greater than or equal to 60 wt. % acid leachate). For example, if the first separated portion weighs 100 grams and comprises greater than or equal to 60 grams of refined silica and the second separated portion weighs 100 grams and comprises greater than or equal to 60 grams of acid leachate, then the first separated portion comprises greater than or equal to 60 wt. % refined silica and the second separated portion comprises greater than or equal to 60 wt. % acid leachate.

According to certain embodiments, the ash can be further processed (e.g., using electrowinning, pH-based precipitation, and/or electrorefining, for example, in any order) to obtain other components instead of or in addition to refined silica. For example, in some embodiments, the acid leachate may be subjected to electrowinning, electrorefining, and/or pH-based precipitation, in any order. For example, in some cases, the acid leachate is first subjected to electrowinning (optionally followed by electrorefining) and then pH-based precipitation. As another example, in certain cases, the acid leachate is first subjected to pH-based precipitation and then electrowinning (optionally followed by electrorefining). Without wishing to be bound by theory, it is believed that in certain cases it is beneficial to electrowin prior to pH-based precipitation, for example, when the precipitated substance is present in a small amount (e.g., less than or equal to 10 wt. %, less than or equal to 5 wt. %, less than or equal to 3 wt. % or less than or equal to 1 wt. % of the ash, acid leachate, and/or solution).

In some embodiments, the further processing steps comprise sequential steps. For example, in certain instances, the electrowinning comprises sequential steps (e.g., electrowinning at one voltage to obtain one metal and then electrowinning at a different voltage to obtain another metal). In some cases, the pH-based precipitation comprises sequential steps (e.g., precipitating one metal salt, such as a metal hydroxide, at one pH and then precipitating another metal salt, such as another metal hydroxide, at another pH). In some embodiments, the sequential electrowinning and/or sequential pH-based precipitation comprises successively lowering the voltage and/or pH. In certain embodiments, the sequential electrowinning and/or sequential pH-based precipitation comprises successively increasing the voltage and/or pH.

According to certain embodiments, the method further comprises electrowinning (e.g., electrowinning the acid leachate). In some cases, electrowinning (e.g., electrowinning the acid leachate) comprises applying an electrical potential of greater than or equal to −5 V, greater than or equal to −4 V, greater than or equal to −3 V, greater than or equal to −2 V, greater than or equal to −1 V, greater than or equal to −0.75 V, greater than or equal to −0.5 V, greater than or equal to −0.25 V, or greater than or equal to 0 V vs the standard hydrogen electrode. In certain instances, electrowinning (e.g., electrowinning the acid leachate) comprises applying an electrical potential of less than or equal to 2 V, less than or equal to 1 V, less than or equal to 0 V, less than or equal to −0.25 V, less than or equal to −0.5 V, less than or equal to −0.75 V, less than or equal to −1 V, or less than or equal to −2 V vs the standard hydrogen electrode. Combinations of these ranges are also possible (e.g., greater than or equal to −5 V and less than or equal to 2 V or greater than or equal to −3 V and less than or equal to 2 V).

In accordance with some embodiments, applying an electrical potential comprises applying a constant potential. In certain embodiments, applying an electrical potential comprises applying a varying potential (e.g., a time-varying potential, a sequence of potential pulses, or a stepwise increasing or decreasing sequence of potentials).

In certain embodiments, electrowinning (and/or electrorefining) comprises using conductive electrodes of sheet configuration. In some embodiments, the electrodes have a higher surface area per projected area and/or higher surface area per gram of electrode material than a sheet electrode, including electrodes of mesh, foam, weave, or mat configuration. In some embodiments the electrode comprises one or more electronically conductive materials, such as a metal, a metal alloy, a metal carbide, a metal oxide, a metal nitride, or carbon. In some embodiments the electrodes comprise fibers, whiskers, nanofibers, nanotubes, or other high surface area morphologies. In some embodiments the electrodes comprise carbon nanofibers or carbon nanotubes.

In certain embodiments, the specific surface area of the electrowinning electrode is greater than or equal to 0.1 m²/g, greater than or equal to 0.5 m²/g, greater than or equal to 1 m²/g, greater than or equal to 5 m²/g, or greater than or equal to 10 m²/g. In some embodiments, the specific surface area of the electrowinning electrode is less than or equal to 1000 m²/g, less than or equal to 500 m²/g, less than or equal to 300 m²/g, or less than or equal to 200 m²/g. Combinations of these ranges are also possible (e.g., greater than or equal to 0.1 m²/g and less than or equal to 1000 m²/g, greater than or equal to 0.5 m²/g and less than or equal to 500 m²/g, greater than or equal to 5 m²/g and less than or equal to 300 m²/g, or greater than or equal to 10 m²/g and less than or equal to 200 m²/g).

In some embodiments, the electrowinning (and/or electrorefining) apparatus is a flow-by design, by which it is meant that the acid leachate flows at least in some portion of the apparatus in a direction parallel to the plane of an electrode, while the electric field provided by the electrodes is at least in some portion of the apparatus normal to the direction of flow. The apparatus comprises one or more electrodes held at positive potential, and one or more electrodes held at negative potential, past which the acid leachate is flowed. When more than one electrode is used, the electrodes are each held at the same, or different, electrical potential.

In some embodiments, the electrowinning (and/or electrorefining apparatus) is a flow-through design, by which it is meant that at least an electrode of the apparatus is porous (non-limiting examples being a mesh, foam, weave, and/or mat of fibers), and the acid leachate flows at least in some portion of the apparatus in a direction normal to the plane of said electrode (e.g., including through the porous electrode), while the electric field provided by the electrodes is at least in some portion of the apparatus parallel to the direction of flow. The apparatus comprises one or more electrodes held at positive potential, and one or more electrodes held at negative potential, past which the acid leachate is flowed. When more than one electrode is used, the electrodes are each held at the same, or different, electrical potential.

In some embodiments, the electrowinning (and/or electrorefining apparatus) comprises a single chamber containing one or more electrodes held at positive potential and one or more electrodes held at negative potential. In some embodiments, the electrowinning (and/or electrorefining) apparatus comprises more than one chamber (e.g., 1-20, 2-20, 1-10, 2-10, 2-5, or 1-5 chamber(s)), each of which contains one or more electrodes held at positive potential and one or more electrodes held at negative potential. In some embodiments, the electrowinning (and/or electrorefining) apparatus comprises one or more reference electrodes relative to which the electrical potential of a positive electrode and/or a negative electrode is measured. In some embodiments, the acid leachate is flowed once through said chamber or chambers. In some embodiments, the acid leachate is recirculated and flowed two or more times through said chamber or chambers. In some embodiments, the acid leachate is stirred (e.g., as disclosed elsewhere herein) while in one or more chambers. In some embodiments, flow of the acid leachate through said chamber or chambers is continuous, and in other embodiments, said flow is interrupted, to allow a longer residence time of the acid leachate within said chamber or chambers than in the instance of continuous flow.

In some embodiments, electrowinning the acid leachate produces one or more electroplated metals. Examples of suitable electroplated metals include Mn, Zn, Cr, Fe, Cd, Co, Ni, Pb, Cu, Bi, As, Ag, and Hg. Without wishing to be bound by theory, it is believed that electrowinning is more effective than pH-based precipitation in precipitating metals present in trace amounts in the ash. In certain cases, the one or more electroplated metals comprises a metal that was present in an amount of less than or equal to 10 wt. %, less than or equal to 5 wt. %, less than or equal to 3 wt. % or less than or equal to 1 wt. % of the ash. In some instances, the one or more electroplated metals comprises a metal that was present in an amount of greater than or equal to 1 part per billion (ppb) by weight, greater than or equal to 1 part per million (ppm), or greater than or equal to 0.1 wt. % of the ash. Combinations of these ranges are also possible (e.g., greater than or equal to 1 ppb and less than or equal to 10 wt. %, greater than or equal to 1 ppm and less than or equal to 1 wt. %, greater than or equal to 1 ppm and less than or equal to 3 wt. %, or greater than or equal to 0.1 wt. % and less than or equal to 5 wt. % of the ash).

In accordance with certain embodiments, electrowinning the acid leachate produces at least two electroplated metals (e.g., at least 3, at least 4, at least 5; less than or equal to 10, less than or equal to 8, less than or equal to 6; combinations are also possible). Without wishing to be bound by theory, it is believed that, in some instances, it is more efficient to electroplate multiple metals and then use subsequent methods (e.g., electrorefining, redissolution, mechanical scraping, and/or gravity separation) to separate them than to electroplate metals one at a time. In some embodiments, the method further comprises electrorefining the at least two electroplated metals to at least partially separate at least one electroplated metal from the other. For example, in some embodiments, at least partially separating at least one electroplated metal from the other comprises producing a first separated metal portion and a second separated metal portion, wherein the first separated metal portion has a relatively large amount (by weight) of a first electroplated metal compared to the amount in the second separated portion, and the second separated portion has a relatively large amount of a second electroplated metal compared to the amount in the first separated portion. For example, in some cases, the first separated metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a first electroplated metal from the electroplated metals. In some embodiments, the first separated metal portion comprises 100 wt. % of a first electroplated metal from the electroplated metals. In certain instances, the second separated metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a second electroplated metal from the electroplated metals. In some embodiments, the second separated metal portion comprises 100 wt. % of a second electroplated metal from the electroplated metals. Combinations of these ranges are also possible (e.g., the first separated metal portion comprises greater than or equal to 60 wt. % of a first electroplated metal from the electroplated metals and the second separated metal portion comprises greater than or equal to 60 wt. % of a second electroplated metal from the electroplated metals). For example, if the electroplated metals comprise 100 grams of a first electroplated metal and 100 grams of a second electroplated metal and the first separated metal portion comprises greater than or equal to 60 grams of the first electroplated metal and the second separated metal portion comprises greater than or equal to 60 grams of the second electroplated metal, then the first separated portion comprises greater than or equal to 60 wt. % of the first electroplated metal from the electroplated metals and the second separated metal portion comprises greater than or equal to 60 wt. % of the second electroplated metal from the electroplated metals.

In certain embodiments, the first separated metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a first electroplated metal. In some embodiments, the first separated metal portion comprises 100 wt. % of a first electroplated metal. In certain instances, the second separated metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a second electroplated metal. In some embodiments, the second separated metal portion comprises 100 wt. % of a second electroplated metal. Combinations of these ranges are also possible (e.g., the first separated metal portion comprises greater than or equal to 60 wt. % of a first electroplated metal and the second separated metal portion comprises greater than or equal to 60 wt. % of a second electroplated metal). For example, if the first separated metal portion weighs 100 grams and greater than or equal to 60 grams (greater than or equal to 60 wt. %) of that is a first electroplated metals, while the second separated metal portion also weighs 100 grams and greater than or equal to 60 grams (greater than or equal to 60 wt. %) of that is a second electroplated metal.

In some embodiments, electrowinning the acid leachate further produces an aqueous solution (e.g., in addition to electroplated metals). In certain instances, the method comprises adding a base to the aqueous solution. In some cases, the base comprises any base disclosed herein, such as a base produced in a reactor. Examples of suitable bases include NaOH, LiOH, and/or KOH. In certain embodiments, adding the base to the aqueous solution precipitates one or more metal salts (e.g., metal hydroxides). According to some embodiments, the metal hydroxide comprises any metal hydroxide disclosed herein, such as calcium hydroxide, magnesium hydroxide, strontium hydroxide, barium hydroxide, manganese hydroxide, iron oxide, cobalt hydroxide, nickel hydroxide, zinc hydroxide, zirconium hydroxide, cerium hydroxide, vanadium hydroxide, neodymium hydroxide, dysprosium hydroxide, cadmium hydroxide, lead hydroxide, silicon hydroxide, and/or aluminum hydroxide. In some embodiments the precipitated hydroxide is a mixed hydroxide comprising more than one metal (e.g., a combination of any two metal hydroxides disclosed herein, such as Ca—Mg hydroxide, Ba—Sr hydroxide, Ni—Co hydroxide, and the like). In some cases, precipitating a substance (e.g., a metal salt, such as a metal hydroxide) comprises precipitating some (e.g., at least 25 wt. %, at least 50 wt. %, at least 75 wt. %, at least 90 wt. %, or all) of two or more solubilized ions, elements, and/or compounds to form a solid.

In accordance with certain embodiments, the base (e.g., any base disclosed herein) comprises a precipitant. Examples of suitable precipitants include compounds providing an anion that results in precipitation of a metal nitrate, metal sulfate, metal chloride, metal carbonate, metal oxalate, or other metal salts. Examples of precipitants include CO₂ (e.g., to precipitate a carbonate, such as CaCO₃ or MgCO₃), sulfate ions (e.g., sodium sulfate) (e.g., to precipitate a sulfate, such as CaSO₄ or MgSO₄), fluoride, chloride, sulfite, and/or phosphate.

According to certain embodiments, the method comprises adding a base (e.g., any base disclosed herein, such as base produced in a reactor) to the refined silica. In some cases, adding the base to the refined silica forms a basic solution (e.g., a solution with a pH greater than 7, such as a solution with a pH greater than 8) and a solid. In accordance with some embodiments, the method comprises at least partially separating the solid from the basic solution (e.g., using centrifugation and/or filtration, such as vacuum filtration and/or gravity filtration) to form a separated basic solution.

In some embodiments, at least partially separating the solid from the basic solution comprises producing a first separated portion and a second separated portion, wherein the first separated portion has a relatively large percentage (by weight) of the solid produced compared to the second separated portion, and the second separated portion has a relatively large percentage (by weight) of the basic solution produced compared to the first separated portion. For example, in some cases, the first separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of the solid produced from the addition. In some embodiments, the first separated portion comprises 100 wt. % of the solid produced from the addition. In certain instances, the second separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of the basic solution produced from the addition. In some embodiments, the second separated portion comprises 100 wt. % of the basic solution produced from the addition. Combinations of these ranges are also possible (e.g., the first separated portion comprises greater than or equal to 60 wt. % of the solid produced from the addition and the second separated portion comprises greater than or equal to 60 wt. % of the basic solution produced from the addition). For example, if adding a base to the refined silica produces 100 grams of solid and 100 grams of basic solution and the first separated portion comprises greater than or equal to 60 grams of solid and the second separated portion comprises greater than or equal to 60 grams of basic solution, then the first separated portion comprises greater than or equal to 60 wt. % of the solid produced from the addition and the second separated portion comprises greater than or equal to 60 wt. % of the basic solution produced from the addition.

In some embodiments, the first separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of the solid. In some embodiments, the first separated portion comprises 100 wt. % of the solid. In certain instances, the second separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of the basic solution. In some embodiments, the first separated portion comprises 100 wt. % of the basic solution. Combinations of these ranges are also possible (e.g., the first separated portion comprises greater than or equal to 60 wt. % of the solid and the second separated portion comprises greater than or equal to 60 wt. % of the basic solution). For example, if the first separated portion weighs 100 grams and comprises greater than or equal to 60 grams of the solid, and the second separated portion weighs 100 grams and comprises greater than or equal to 60 grams of the basic solution, then the first separated portion comprises greater than or equal to 60 wt. % of the solid and the second separated portion comprises greater than or equal to 60 wt. % of the basic solution.

In certain embodiments, the method comprises adding an acid (e.g., any acid disclosed herein, such as an acid produced in a reactor) to the separated basic solution to form an acidic solution (e.g., a solution with a pH less than 7, such as less than or equal to 6).

In some embodiments, the method comprises electrowinning (e.g., as disclosed elsewhere herein) the acidic solution to produce one or more electroplated noble metals. Examples of noble metals (e.g., electroplated noble metals) that can be plated using electrowinning include gold, silver, platinum, palladium, rhodium, and iridium. In some instances, electrowinning the acidic solution produces at least two electroplated noble metals (e.g., at least 3, at least 4, at least 5; less than or equal to 10, less than or equal to 8, less than or equal to 6; combinations are also possible). In certain cases, the method further comprises electrorefining the at least two electroplated noble metals to separate at least one electroplated noble metal from the other. For example, in some embodiments, at least partially separating at least one electroplated noble metal from the other comprises producing a first separated noble metal portion and a second separated noble metal portion, wherein the first separated noble metal portion has a relatively large percentage (by weight) of a first electroplated noble metal from the electroplated noble metals compared to the second separated noble metal portion, and the second separated noble metal portion has a relatively large percentage (by weight) of a second electroplated noble metal from the electroplated noble metals compared to the first separated noble metal portion. For example, in some cases, the first separated noble metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a first electroplated noble metal from the electroplated noble metals. In some embodiments, the first separated noble metal portion comprises 100 wt. % of a first electroplated noble metal from the electroplated noble metals. In certain instances, the second separated noble metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a second electroplated noble metal from the electroplated noble metals. In some embodiments, the second separated noble metal portion comprises 100 wt. % of a second electroplated noble metal from the electroplated noble metals. Combinations of these ranges are also possible (e.g., the first separated noble metal portion comprises greater than or equal to 60 wt. % of a first electroplated noble metal from the electroplated noble metals and the second separated noble metal portion comprises greater than or equal to 60 wt. % of a second electroplated noble metal from the electroplated noble metals). For example, if the electroplated noble metals comprise 100 grams of a first electroplated noble metal and 100 grams of a second electroplated noble metals, and the first separated noble metal portion comprises greater than or equal to 60 grams of a first electroplated noble metal and the second separated portion comprises greater than or equal to 60 grams of a second electroplated noble metal, then the first separated noble metal portion comprises greater than or equal to 60 wt. % of the first electroplated noble metal from the electroplated noble metals and the second separated noble metal portion comprises greater than or equal to 60 wt. % of the second electroplated noble metal from the electroplated noble metals.

For example, in some cases, the first separated noble metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a first electroplated noble metal. In some embodiments, the first separated noble metal portion comprises 100 wt. % of a first electroplated noble metal. In certain instances, the second separated noble metal portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a second electroplated noble metal. In some embodiments, the second separated noble metal portion comprises 100 wt. % of a second electroplated noble metal. Combinations of these ranges are also possible (e.g., the first separated noble metal portion comprises greater than or equal to 60 wt. % of a first electroplated metal and the second separated noble metal portion comprises greater than or equal to 60 wt. % of a second electroplated noble metal). For example, if the first separated noble metal portion weighs 100 grams and comprises greater than or equal to 60 grams of a first electroplated noble metal, and the second separated noble metal portion weighs 100 grams and comprises greater than or equal to 60 grams of a second electroplated noble metal, then the first separated noble metal portion comprises greater than or equal to 60 wt. % of a first electroplated noble metal and the second separated noble metal portion comprises greater than or equal to 60 wt. % of a second electroplated noble metal.

In some embodiments, the method comprises producing acid and/or base in a reactor. In some embodiments, the reactor comprises an electrochemical reactor, a chlor-alkali reactor, a non-electrolytic reactor (e.g., an acid burner), and/or a fuel cell (e.g., an H₂/Cl₂ fuel cell). In certain embodiments, the acid and/or base produced in a reactor is undiluted, diluted, and/or concentrated when used as described elsewhere herein. Examples of suitable reactors are disclosed in, for example, U.S. Provisional Patent Application No. 62/793,294, filed Jan. 16, 2019; U.S. Provisional Patent Application No. 62/800,220, filed Feb. 1, 2019; U.S. Provisional Patent Application No. 62/818,604, filed Mar. 14, 2019; U.S. Provisional Patent Application No. 62/887,143, filed Aug. 15, 2019; U.S. Provisional Patent Application No. 62/962,061, filed Jan. 16, 2020; U.S. Provisional Patent Application No. 63/018,696, filed May 1, 2020; U.S. Provisional Patent Application No. 63/054,683, filed Jul. 21, 2020; International Patent Application No. PCT/US2020/013837, filed Jan. 16, 2020, published as WO 2020/150449 on Jul. 23, 2020; International Patent Application No. PCT/US2020/022672, filed Mar. 13, 2020, published as WO 2020/186178 on Sep. 17, 2020; and International Patent Application No. PCT/US2021/029918, filed Apr. 29, 2021; all of which are hereby incorporated by reference in their entireties for all purposes.

In some embodiments, an acid and/or an acidic solution disclosed herein has a pH of less than 7, less than or equal to 6, less than or equal to 5, less than or equal to 4, less than or equal to 3, less than or equal to 2, less than or equal to 1, or less than or equal to 0. In some embodiments, an acid and/or an acidic solution disclosed herein has a pH of greater than or equal to −5, greater than or equal to −2, greater than or equal to 0, greater than or equal to 1, greater than or equal to 2, greater than or equal to 3, greater than or equal to 4, or greater than or equal to 5. In certain cases, an acid and/or an acidic solution disclosed herein has a pH of 0. Combinations of these ranges are also possible (e.g., greater than or equal to −5 and less than 7, greater than or equal to −2 and less than or equal to 1, greater than or equal to 0 and less than 7, or greater than or equal to 0 and less than or equal to 5).

The acid may have any of a variety of suitable concentrations. In some embodiments, the acid has a concentration of greater than or equal to 0.000001 M, greater than or equal to 0.00001 M, greater than or equal to 0.0001 M, greater than or equal to 0.001 M, greater than or equal to 0.01 M, greater than or equal to 0.1 M, greater than or equal to 0.5 M, greater than or equal to 1 M, greater than or equal to 3 M, greater than or equal to 5 M, greater than or equal to 7 M, or greater than or equal to 10 M. In certain embodiments, the acid has a concentration of less than or equal to 12 M, less than or equal to 10 M, less than or equal to 7 M, less than or equal to 5 M, less than or equal to 3 M, or less than or equal to 1 M. Combinations of these ranges are also possible (e.g., greater than or equal to 0.000001 M and less than or equal to 12 M or greater than or equal to 0.1 M and less than or equal to 10 M).

In certain embodiments, a base and/or a basic solution disclosed herein has a pH of greater than 7, greater than or equal to 8, greater than or equal to 9, greater than or equal to 10, greater than or equal to 11, greater than or equal to 12, greater than or equal to 13, or greater than or equal to 14. In accordance with certain embodiments, a base and/or a basic solution disclosed herein has a pH of less than or equal to 19, less than or equal to 16, less than or equal to 14, less than or equal to 13, less than or equal to 12, less than or equal to 11, less than or equal to 10, less than or equal to 9, or less than or equal to 8. In some cases, a base and/or a basic solution disclosed herein has a pH of 14. Combinations of these ranges are also possible (e.g., greater than 7 and less than or equal to 19, greater than or equal to 9 and less than or equal to 16, greater than 7 and less than or equal to 14, or greater than or equal to 9 and less than or equal to 14).

The base may have any of a variety of suitable concentrations. In some embodiments, the base has a concentration of greater than or equal to 0.000001 M, greater than or equal to 0.00001 M, greater than or equal to 0.0001 M, greater than or equal to 0.001 M, greater than or equal to 0.01 M, greater than or equal to 0.1 M, greater than or equal to 0.5 M, greater than or equal to 1 M, greater than or equal to 3 M, greater than or equal to 5 M, greater than or equal to 7 M, greater than or equal to 10 M, greater than or equal to 15 M, or greater than or equal to 20 M. In certain embodiments, the base has a concentration of less than or equal to 25 M, less than or equal to 20 M, less than or equal to 15 M, less than or equal to 10 M, less than or equal to 7 M, less than or equal to 5 M, or less than or equal to 3 M. Combinations of these ranges are also possible (e.g., greater than or equal to 0.1 M and less than or equal to 25 M or greater than or equal to 0.1 M and less than or equal to 10 M).

In certain embodiments, the volume of acid and/or base added to the ash (and/or another substance disclosed herein, such as acid leachate) is less than or equal to 10 mL acid and/or base per 0.1 grams of ash (or other substance) or less than or equal to 10 mL acid and/or base per 1 gram of ash (or other substance). In some embodiments, the volume of acid and/or base added to the ash (and/or another substance disclosed herein) is greater than or equal to 10 mL acid and/or base per 10 grams of ash (or other substance) or greater than or equal to 10 mL of acid and/or base per 1 gram of ash (or other substance). Combination of these ranges are also possible (e.g., greater than or equal to 10 mL acid and/or base per 10 grams of ash (or other substance) and less than or equal to 10 mL acid and/or base per 0.1 grams of ash (or other substance)).

In some embodiments, steps disclosed herein (e.g., dissolution, adding base, adding acid, precipitating, etc.) may have a separation step (e.g., using centrifugation and/or filtration, such as vacuum filtration and/or gravity filtration) in between them (e.g., to separate solid from liquid). In certain cases, a separation step produces a first separated portion and a second separated portion, wherein the first separated portion has a relatively large percentage (by weight) of a first component (e.g., a solid) compared to the second separated portion, and the second separated portion has a relatively large percentage (by weight) of a second component compared to the first separated portion. For example, in some cases, the first separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a first component (e.g., a solid) from the pre-separated mix. In some embodiments, the first separated portion comprises 100 wt. % of the first component (e.g., a solid) from the pre-separated mix. In certain instances, the second separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a second component (e.g., a liquid) from the pre-separated mix. In some embodiments, the second separated portion comprises 100 wt. % of the second component (e.g., a liquid) from the pre-separated mix. Combinations of these ranges are also possible (e.g., the first separated portion comprises greater than or equal to 60 wt. % of a first component (e.g., a solid) from the pre-separated mix and the second separated portion comprises greater than or equal to 60 wt. % of a second component (e.g., a liquid) from the pre-separated mix). For example, if a pre-separated mix comprises 100 grams of a first component and 100 grams of a second component and the first separated portion comprises greater than or equal to 60 grams of the first component and the second separated portion comprises greater than or equal to 60 grams of the second component, then the first separated portion comprises greater than or equal to 60 wt. % of the first component from the pre-separated mix and the second separated portion comprises greater than or equal to 60 wt. % of the second component from the pre-separated mix.

In certain embodiments, the first separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a first component (e.g., a solid). In some embodiments, the first separated portion comprises 100 wt. % of a first component (e.g., a solid). In certain instances, the second separated portion comprises greater than or equal to 60 wt. %, greater than or equal to 70 wt. %, greater than or equal to 80 wt. %, greater than or equal to 90 wt. %, greater than or equal to 95 wt. %, or greater than or equal to 99 wt. % of a second component (e.g., a liquid). In some embodiments, the second separated portion comprises 100 wt. % of a second component (e.g., a liquid). Combinations of these ranges are also possible (e.g., the first separated portion comprises greater than or equal to 60 wt. % of a first component (e.g., a solid) and the second separated portion comprises greater than or equal to 60 wt. % of a second component (e.g., a liquid)). For example, if the first separated portion weighs 100 grams and comprises greater than or equal to 60 grams of a first component and the second separated portion weighs 100 grams and comprises greater than or equal to 60 grams of a second component, then the first separated portion comprises greater than or equal to 60 wt. % of the first component and the second separated portion comprises greater than or equal to 60 wt. % of the second component.

In certain embodiments, various factors other than pH may affect the solubility of the various substances and/or components disclosed herein. For example, in some embodiments, temperature affects the solubility of one or more substances and/or components. In some embodiments, the temperature of one or more of the steps (e.g., dissolution step, precipitation step, electrowinning, electrorefining, addition of base, and/or addition of acid) may each independently be greater than or equal to −10° C., greater than or equal to −5° C., greater than or equal to 0° C., greater than or equal to 5° C., greater than or equal to 10° C., greater than or equal to 15° C., greater than or equal to 20° C., greater than or equal to 25° C., greater than or equal to 30° C., greater than or equal to 40° C., or greater than or equal to 50° C. In certain embodiments, the temperature of one or more of the steps (e.g., dissolution step, precipitation step, electrowinning, electrorefining, addition of base, and/or addition of acid) may each independently be less than or equal to 100° C., less than or equal to 90° C., less than or equal to 80° C., less than or equal to 70° C., less than or equal to 60° C., less than or equal to 50° C., less than or equal to 40° C., less than or equal to 30° C., less than or equal to 25° C., less than or equal to 20° C., less than or equal to 15° C., less than or equal to 10° C., less than or equal to 5° C., or less than or equal to 0° C. In some embodiments, the temperature of one or more of the steps (e.g., dissolution step, precipitation step, electrowinning, electrorefining, addition of base, and/or addition of acid) may be room temperature. Combinations of these ranges are also possible (e.g., greater than or equal to −10° C. and less than or equal to 50° C., greater than or equal to −5° C. and less than or equal to 10° C., greater than or equal to 15° C. and less than or equal to 25° C., greater than or equal to 25° C. and less than or equal to 60° C., or greater than or equal to 50° C. and less than or equal to 100° C.).

In certain cases, the temperature is approximately the same (e.g., within 5 degrees Celsius, within 3 degrees Celsius, or within 1 degree Celsius) for some or all of the steps (e.g., dissolution step, precipitation step, electrowinning, electrorefining, addition of base, and/or addition of acid). In some instances, the temperature is different (e.g., greater than 5 degrees, greater than 10 degrees, or greater than 15 degrees different) for some or all of the steps (e.g., dissolution step, precipitation step, electrowinning, electrorefining, addition of base, and/or addition of acid).

According to certain embodiments, temperature of a precipitation step affects the size of the crystals formed. For example, in some cases, a higher temperature (e.g., greater than or equal to 50° C.) results in smaller crystals, while a lower temperature (e.g., less than or equal to 15° C.) results in larger crystals.

In some cases, agitation (e.g., stirring, sonication, and/or shaking) affects the solubility of one or more substances (e.g., ash, metal, metal hydroxide, and/or silica) and/or components. In certain instances, one or more of the steps (e.g., dissolution step, precipitation step, electrowinning, electrorefining, addition of base, and/or addition of acid) comprises agitation.

In certain embodiments, a vessel, apparatus, substance, and/or component disclosed herein is stirred at an appropriate rate. For example, in some embodiments, a vessel, apparatus, substance, and/or component disclosed herein is stirred at a rate of greater than or equal to 0 rpm, greater than or equal to 50 rpm, greater than or equal to 100 rpm, greater than or equal to 200 rpm, greater than or equal to 300 rpm, or greater than or equal to 400 rpm. In certain instances, a vessel, apparatus, substance, and/or component disclosed herein is stirred at a rate of less than or equal to 500 rpm, less than or equal to 400 rpm, less than or equal to 300 rpm, less than or equal to 200 rpm, or less than or equal to 100 rpm. Combinations of these ranges are also possible (e.g., greater than or equal to 0 rpm and less than or equal to 500 rpm or greater than or equal to 50 rpm and less than or equal to 500 rpm). In some cases, a vessel, substance, and/or component disclosed herein is not stirred.

In accordance with some embodiments, the amount of time allowed for a given step (e.g., dissolution step, precipitation step, electrowinning, electrorefining, addition of base, and/or addition of acid) affects the solubility of one or more substances (e.g., ash, metal, metal hydroxide, and/or silica) and/or components. According to certain embodiments, the time for one or more of the steps (e.g., dissolution step, precipitation step, electrowinning, electrorefining, addition of base, and/or addition of acid) may each independently be greater than or equal to 1 minute, greater than or equal to 5 minutes, greater than or equal to 10 minutes, greater than or equal to 15 minutes, greater than or equal to 30 minutes, greater than or equal to 1 hour, greater than or equal to 6 hours, greater than or equal to 12 hours, or greater than or equal to 24 hours. In some embodiments, the time for one or more of the steps (e.g., dissolution step, precipitation step, electrowinning, electrorefining, addition of base, and/or addition of acid) may each independently be less than or equal to 48 hours, less than or equal to 36 hours, less than or equal to 24 hours, less than or equal to 12 hours, less than or equal to 6 hours, less than or equal to 1 hour, less than or equal to 30 minutes, less than or equal to 15 minutes, or less than or equal to 5 minutes. Combinations of these ranges are also possible (e.g., greater than or equal to 1 minute and less than or equal to 48 hours, or greater than or equal to 5 minutes and less than or equal to 30 minutes).

According to certain embodiments, the amount of time allowed for a precipitation step affects the size of the crystals formed. For example, in some cases, a shorter precipitation time (e.g., less than or equal to 5 minutes) results in smaller crystals, while a longer precipitation times (e.g., greater than or equal to 10 minutes) results in larger crystals.

In some embodiments, an applied electrical potential affects the solubility of one or more substances and/or components. In some embodiments, the applied electrical potential (e.g., by electrowinning) during one or more of the dissolution step(s) and/or precipitation step(s) may each independently be greater than or equal to −5 V, greater than or equal to −3 V, greater than or equal to −1 V, or greater than or equal to 0 V vs the standard hydrogen electrode. In certain embodiments, the applied electrical potential (e.g., by electrowinning) during one or more of the dissolution step(s) and/or precipitation step(s) may each independently be less than or equal to 2 V, less than or equal to 0 V, or less than or equal to −2 V vs the standard hydrogen electrode. Combinations of these ranges are also possible (e.g., greater than or equal to −5 V and less than or equal to 2 V or greater than or equal to −3 V and less than or equal to 2 V).

In some embodiments, the method comprises running a reactor (e.g., any reactor described herein). In certain cases, running the reactor comprises applying current to an electrode of the reactor. In some embodiments, running the reactor results in at least one chemical reaction occurring within the reactor.

In some embodiments, the method and/or reactor is powered at least in part (e.g., at least 10%, at least 25%, at least 50%, at least 75%, at least 90%, or 100%) by renewable electricity (e.g., solar energy, wind energy, and/or hydroelectric power). In certain cases, the method and/or reactor has lower net carbon emissions (e.g., at least 10% lower, at least 25% lower, at least 50% lower, at least 75% lower, or at least 90% lower) than substantially similar systems that do not comprise a reactor. In some instances, the method and/or reactor has net-zero carbon emissions.

In certain embodiments, the reactor is configured to provide a liquid solvent stream (e.g., any liquid solvent stream disclosed herein) (e.g., acidic and/or basic). In some embodiments, the reactor is configured to provide the liquid stream to one or more vessels (e.g., a container that is not open to the atmosphere). According to certain embodiments, one or more vessels are configured for placing a substance (e.g., any substance disclosed herein, such as ash) and/or solid in contact with the liquid solvent stream. For example, in FIG. 1, in certain cases, vessel 105 is configured for placing a substance (e.g., ash 101) in contact with the liquid solvent stream (e.g., a liquid solvent stream comprising acid 102).

In some embodiments, the system comprises greater than or equal to 1, greater than or equal to 2, greater than or equal to 3, greater than or equal to 4, or greater than or equal to 5 vessels. In some cases, the system comprises less than or equal to 6, less than or equal to 5, less than or equal to 4, less than or equal to 3, or less than or equal to 2 vessels. Combinations of these ranges are also possible (e.g., 1-6 vessels). In certain embodiments, one or more vessels are fluidically connected to the reactor.

In certain embodiments, a reactor (e.g., an electrochemical reactor) provides a liquid solvent stream (e.g., acid and/or base). In some embodiments, a vessel places a substance (e.g., any substance disclosed herein, such as ash) in contact with the liquid stream. For example, in some embodiments, acid and/or base flows from a reactor to a vessel (e.g., containing a substance). In some embodiments, the method comprises placing the substance (e.g., any substance disclosed herein, such as ash) and/or solid in the vessel in contact with the liquid solvent stream.

In certain cases, a vessel is fluidically connected to one or more other vessels (e.g., by a conduit, such as a pipe, channel, needle, or tube).

According to some embodiments, the method comprises collecting the acid and/or base. For example, in some embodiments, the method comprises removing the acid and/or base from the reactor in which it was produced. A non-limiting example of a suitable method of collecting the acid and/or base comprises moving the acid and/or base through a conduit (e.g., a pipe, channel, needle, or tube) into a separate container. Other suitable examples of collecting the acid and/or base include moving the acid and/or base directly into a separate container (e.g., a container connected to the reactor by a panel that can be moved to block or allow diffusion of fluids). In some embodiments, the acid and/or base is collected continuously or in batches. In certain embodiments, the acid and/or base is collected automatically or manually.

According to some embodiments, the method comprises storing the acid and/or base. For example, in certain embodiments, once the acid and/or base are collected in a separate container, the method comprises keeping the acid and/or base in the separate container for at least some period of time. In some embodiments, the method comprises storing the acid and/or base for greater than or equal to 5 minutes, greater than or equal to 15 minutes, greater than or equal to 30 minutes, greater than or equal to 1 hour, greater than or equal to 5 hours, greater than or equal to 12 hours, greater than or equal to 1 day, greater than or equal to 2 days, greater than or equal to 3 days, greater than or equal to 1 week, greater than or equal to 2 weeks, or greater than or equal to 1 month. In certain embodiments, the method comprises storing the acid and/or base for less than or equal to 1 year, less than or equal to 6 months, less than or equal to 3 months, less than or equal to 2 months, less than or equal to 1 month, less than or equal to 2 weeks, less than or equal to 1 week, less than or equal to 3 days, less than or equal to 2 days, less than or equal to 1 day, or less than or equal to 12 hours. Combinations of these ranges are also possible (e.g., greater than or equal to 5 minutes and less than or equal to 1 year, greater than or equal to 5 hours and less than or equal to 1 day, or greater than or equal to 1 week and less than or equal to 1 year).

In some embodiments, the methods and/or systems described herein have one or more advantages, such as increased purity of a substance, increased abundance of a substance, reduced waste (e.g., reduced amounts of substances ending up in landfills), and/or reduced costs (e.g., by recycling substances).

### Example 1

This example describes a prophetic process for electrochemical processing of MSWI ash.

The proposed process is an aqueous electrochemical approach to processing of MSWI ash, powered solely by electricity from the waste-to-energy (WTE) plant. The approach will use electrolytic reactors to co-produce acid and base streams for the dissolution, chemical precipitation and electrowinning of ash. Input materials include only water, electricity and low-cost salts; output acids and bases allow separation of fine-particulate, mineral-rich bottom ash into value-added products ranging from lime to rare-earth elements to valuable base and noble metals. Co-benefits of the approach include built-in chemical energy storage that allows asynchronous processing and buffering of electricity output intermittency, and co-production of hydrogen to lower natural gas consumption. In addition to extraction of dilute valuable elements, the proposed technology can upcycle major elements in fly and bottom ash including Ca and Si into valuable products such as hydrated lime for the WTE plant's own flue gas desulfurization, and calcium silicates for cement production.

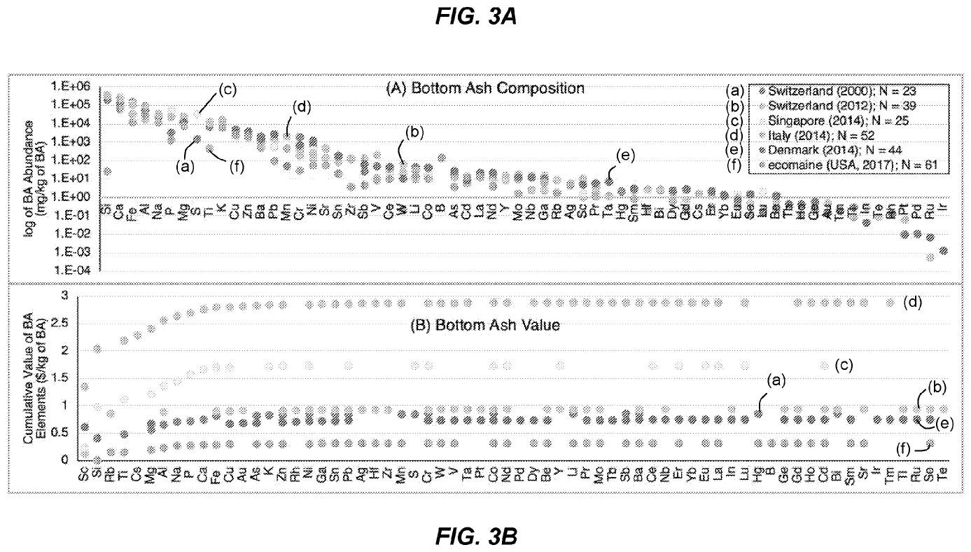

Municipal solid waste disposal is a growing energy, environmental, and societal problem aggravated by ongoing urbanization; the worldwide population of urban residents is projected to increase by ˜35% by 2050. When the elemental makeup of MSWI ash from five different sources representing four countries, plotted in order of decreasing concentration by element in FIG. 3a, is scaled by the corresponding price by element, the cumulative value for each ash, FIG. 3b, ranges from ˜$0.30 to ˜$2.75 per kg ash based on the value of the pure elements. This exceeds the value of other large volume commodity materials such as ordinary Portland cement (OPC) with an average U.S. selling price of $0.12/kg or recycled glass cullet at ˜$0.10/kg. However, most ash is currently ashfilled and has negative value; the average cost of disposal is ˜$50/ton. While WTE plants derive revenue from electricity sales, net gains after subtraction of ˜15% of electricity used for plant operation is only ˜$0.055/kg ash. Much greater value can potentially be realized by directing WTE electricity towards ash processing.

The barrier to unlocking the mineral value of MSWI ash is the absence, heretofore, of cost-effective, environmentally-benign technologies for separating and purifying the elements within. The proposed technology is an innovative solution that capitalizes on the decreasing value of WTE electricity, and instead uses it to electrify ash processing. The main consumables are water and electricity. The proposed process will also take advantage of abundant low-grade heat at WTE plants for functions such as drying precipitated products. This process would use aqueous electrochemistry to produce acids and bases for extraction of valuable elements, followed by recovery using chemical precipitation and electrowinning. It practices process intensification by removing valuable non-metals and concentrating critical materials (CMs) for more efficient recovery. The proposed technology produces no new hazardous waste, and leaves unharvested MSWI ash as powders or slurries.

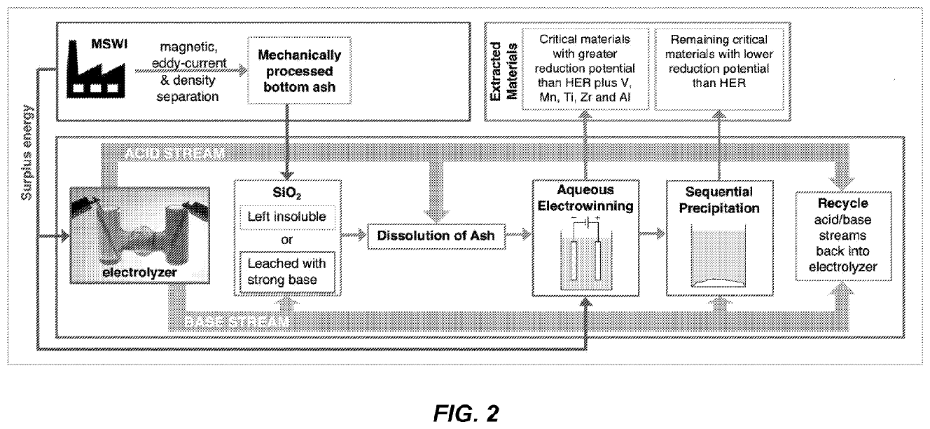

The proposed technology will use ambient-temperature aqueous electrolytic reactors to produce streams of concentrated acids and bases, which are used directly or stored, for subsequent dissolution of components in BA for extraction by sequential precipitation and electrowinning (FIG. 2). This approach is inherently versatile and selective, since utilizing both the acid and base streams allows recovery of virtually all elements of interest in BA. Valuable precipitated products include hydrated lime (Ca(OH)₂), brucite (Mg(OH)₂), gibbsite (Al(OH)₃), and the rare-earth hydroxides. Hydrated lime alone has 0.15/kg value since it is consumed by WTE (and other) power plants for flue gas desulfurization; the proposed technology will help to mitigate CO₂ emissions from limestone calcination. Where other metal salts such as chlorides, sulfates or carbonates are the desired end product, low-cost salts will provide the respective anions for precipitation. Valuable electrowon products include a wide range of metals. For certain valuable trace elements, the solute will be concentrated by solvent extraction or (preferably) electrically-powered reverse osmosis or electrodialysis prior to extraction. The processing operation can be co-located on the WTE site, or remotely at separate plants or at ashfills. When co-located, processing of ash can be carried out synchronously with incineration, or asynchronously with material storage.

In contrast to today's near-zero or negative value of MSWI ash, it will be possible to extract its embodied mineral value with net positive returns that significantly exceed the value of WTE electricity, thereby offering a new, more profitable, value proposition, while also mitigating the growing environmental toll of ash disposal, and benefiting U.S. critical materials security. The methods disclosed herein are capable of separating a wide range of elements, fine inorganic particulates, and metal particles trapped within other inorganics.

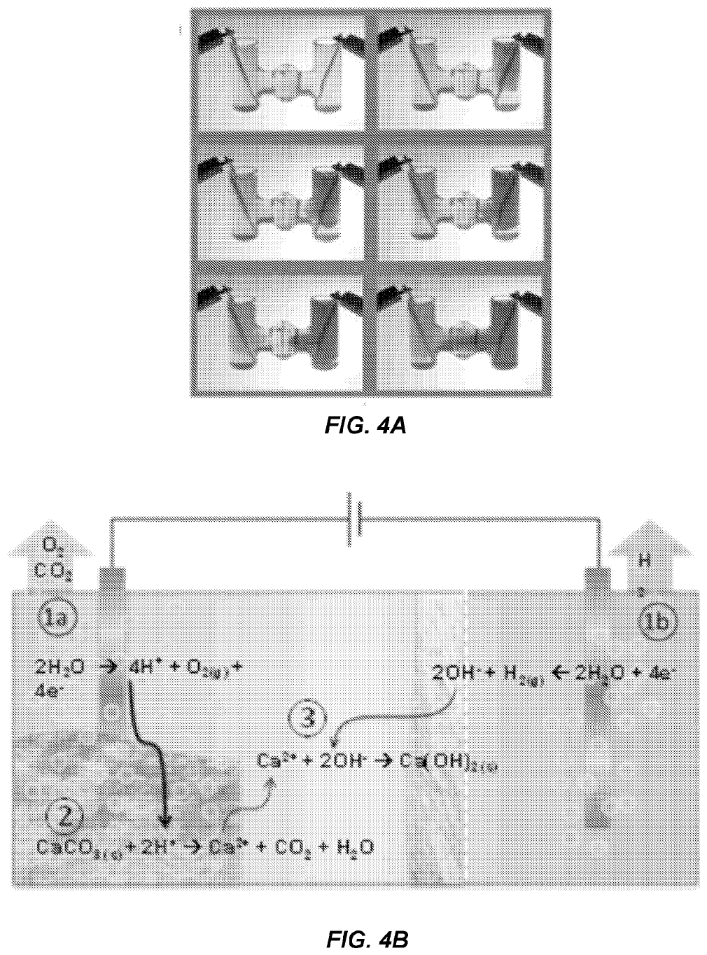

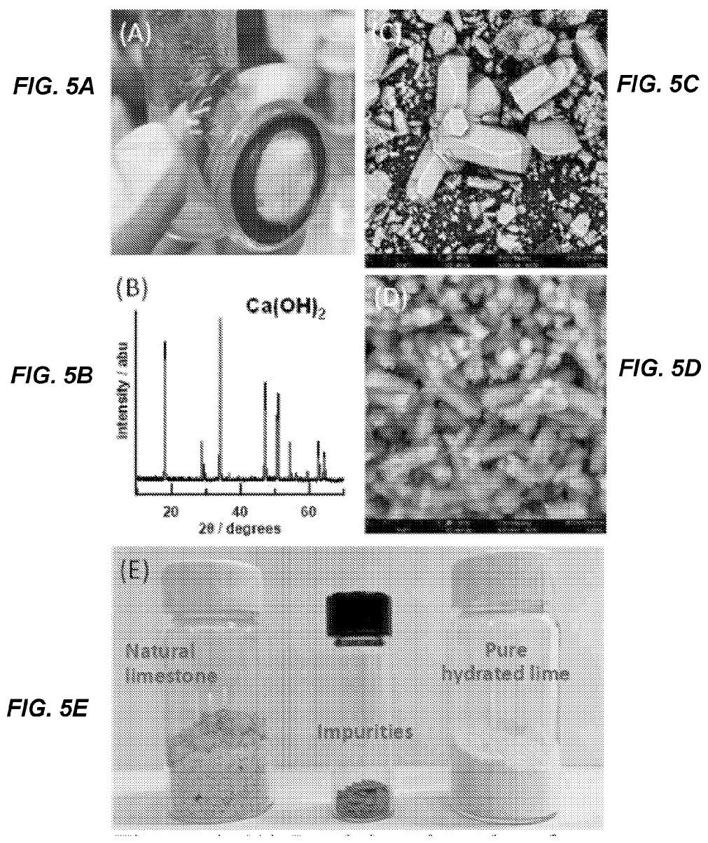

Alkaline electrolyzers and chlor-alkali plants are examples of large-scale electrolytic reactors that operate near ambient temperature and utilize aqueous electrolytes; the former is used to produce hydrogen (co-produced oxygen has secondary value) and the latter is used to produce chlorine gas (co-product NaOH) from NaCl for a wide variety of chlorinated products (e.g., polyvinyl chloride, PVC). The process disclosed herein uses such electrolytic reactors or others, such as electrodialysis reactors, to instead produce acids and bases for extraction and separation of elements in MSWI ash (both fly ash and bottom ash). FIG. 4A illustrates the simultaneous acid (light gray) and base (dark gray) streams produced in an electrolyzer in which the input electrolyte had pH=7 and 1M NaNO₃ was added as a supporting electrolyte to increase solution conductivity and produce a desired mineral acid, which here was nitric acid. FIG. 4B shows the ensuing reactions as CaCO₃ dissolved in the acid produced by the cathode (left), and Ca(OH)₂ precipitated in the base produced by the anode (right). FIG. 5A shows the resulting precipitate, which XRD revealed was single phase Ca(OH)₂ and had a range of controllable morphologies and sizes, FIGS. 5C and 5D. High selectivity for calcium based on pH is illustrated in FIG. 5E; high purity Ca(OH)₂ was readily separated from other constituents in natural limestone.

Unweathered ash is primarily in the form of metal oxides (with some sulphates, chlorides, and phosphates) as incineration has “calcined” most of the metal salts. Through electrolysis, the type and pH of the acid and base are tunable. The output pH is primarily determined by reactor kinetics and electrolyte flow rate, while the acid and base compositions are determined by the electrolyte salt. While in FIGS. 4 and 5, the salt, NaNO₃ produces nitric acid, analogously NaCl produces hydrochloric acid, Na₂SO₄ produces sulfuric acid, NaF produces hydrofluoric acid, and a 1:3 mixture of NaNO₃ to NaCl produces aqua regia, suitable for dissolution of noble metals. The corresponding base produced can be selected to be NaOH, KOH, or others, simply by varying the salt cation.

Thus a diversity of acids and bases can be produced in this approach, enabling great flexibility in designing a process that addresses all desirable elements available in MSWI ash. The selective extraction elements follows the general scheme shown in FIG. 2. By combining dissolution in both acids and bases with selective extraction by chemical precipitation and electrowinning, individual elements, or closely related groups of elements, can be isolated. Furthermore, electrolysis may be decoupled from dissolution and precipitation by separately storing the acids and bases in low-cost tanks (polymers for acid and mild steel for base). The flexibility provided by this chemical storage capability may have operational and economic advantages. While WTE plants currently operate ˜24/7, the ability to have asynchronous operations may allow improved efficiency if, for example, the demand and pricing for output electricity is variable.

The proposed technology will provide, for the first time, a pathway to cost-effectively separate MSWI ash into a range of marketable products with cumulative value that far exceeds the current combined value of electricity from MSW incineration and sales of ash into low-value markets such as SCMs for concrete or fillers in road construction. The process disclosed herein can potentially increase the product revenue of a typical WTE plant by a factor of 8 to 12.

Other impacts include a vast reduction in the volume and environmental costs of future ashfills. Using our approach, even the largest-volume, lowest-unit-value constituent in ash, Si, can be separated and purified (as SiO₂) for use in construction or as clean ashfill. The second largest-volume component of ash, Ca, can be recovered as hydrated lime. The majority of the calcium in both fly ash and bottom ash originates from its use as a consumable in MSW incinerators for flue gas scrubbing. By recovering and reusing this calcium in its preferred form, calcium hydroxide, the proposed technology will directly benefit incinerator economics, and reduce the CO₂ emitted by calcination of new limestone. This particular aspect of the technology could have far-reaching impact beyond MSW disposal, because lime is widely used in combustion power plants of all kinds, and calcium-bearing ash is a byproduct of each. A further strength of the proposed approach is that it directly addresses current pain points in the WTE industry, including low electricity prices and the high cost of ash disposal.

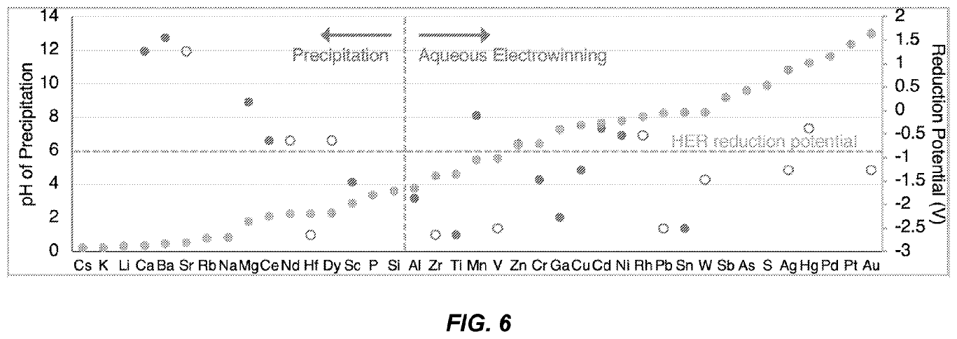

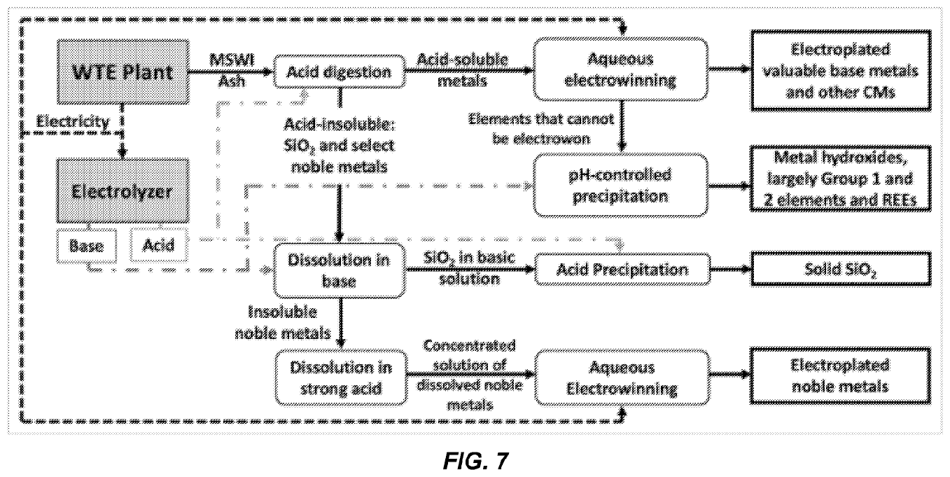

The process strategy was informed by chemical and electrochemical analysis of the specific components known to be present in ash, per FIGS. 3A-3B. FIG. 6 plots the pH above which the metal hydroxide will precipitate (dark gray data points), for the elements of interest in ash (horizontal axis), ordered as an electrochemical series. The light gray data points corresponding to the right vertical scale show the electrowinning potential for each metal, adjusted for its relative concentration in bottom ash. Aqueous electrowinning is generally possible for those elements to the right of the vertical line. Elements near the vertical line may be extracted by precipitation or electrowinning Based on these data, a plausible order-of-operations for processing MSWI ash is illustrated in FIGS. 1 and 6. Silicon, present as SiO₂, is both the most abundant element in ash, and unique in that it dissolves at high pH rather than low. Silica may be selectively leached using a strong base and precipitated with acid, or it may be left insoluble while other ash constituents are leached with acid. In either case, the remaining balance of ash constituents is dissolved in acid solution. (It may be advantageous at this state to exclude difficult-to-dissolve Au and the PGMs and to instead concentrate them as solids for later extraction, e.g., using HCl—HNO₃.)

The acid-dissolved metals are next separated by aqueous electrowinning Selectivity is obtained by starting at high reduction potential, right side of FIG. 6, and working to low potential to sequentially extract the metals. If selectivity is poor, electrorefining or other chemical separations may be considered. Manganese may be electrowon as MnO₂ per an EMD (electrolytic manganese dioxide) process.

Post-electrowinning, the dissolved elements in the left side of FIG. 6 will be sequentially precipitated, for example as hydroxides, by increasing the pH. Metal hydroxides are attractive products because the anion (OH⁻) can be produced solely from water splitting and does not require any other input materials. Hydroxides also decompose cleanly in subsequent pyrolysis when used to synthesize other inorganic compounds. Elements near the vertical line, such as Al, Zr, and Ti, can be electrowon or precipitated as hydroxides. At high pH, Mg hydroxide is readily precipitated at pH >9 followed by hydroxides of Ca, Ba and Sr at pH >11. Since the majority economic value of the alkaline earths comes from Ca (FIG. 3B), e.g., as Ca(OH)₂, trace amounts of Ba and Sr may be acceptable.

Process sequences will be systematically investigated and optimized. In the above example, the salts used for supporting electrolyte are not consumed during electrowinning or precipitation and can be returned to service after recovery of elements. For some metals, a metal chloride, sulfate, carbonate, or other metal salt may be preferable to hydroxide. Conditions favoring precipitation of such metal salts are readily determined and may provide an additional degree of selectivity. Low-cost alkali salts are proposed as the source of the anion. >86% mass efficiency for electrolytic dissolution of CaCO₃ and recovery as Ca(OH)₂ has been demonstrated.

The feasibility of powering the proposed process purely with WTE electricity was assessed as follows. First, the amount of acid ([H⁺]) or base ([OH⁻]) required for dissolution and precipitation of a unit of ash was readily calculated from the ash composition. The electrical energy required to split a stoichiometric equivalent of water was determined from the Faradaic output of an electrolytic reactor, discounted by the reactor inefficiency. This analysis showed that ˜1 kWh of electricity is required for dissolution and precipitation of 1 kg of ash. Added to this energy budget is the electricity consumed in electrowinning. A typical energy consumption in electrowinning processes is 3 kWh/kg. For the ˜11% by mass of ash comprising the elements on the right half of FIG. 6, electrowinning requires ˜0.34 Wh per kg ash. These energy requirements combined, when subtracted from the net electricity output of a typical WTE plant, ˜2.2 kWh per kg of ash produced leaves ˜0.86 kWh/kg ash available to power the balance of plant operations.

An electrolyser modified from the reactor in FIGS. 4 and 5 to allow flow-through of electrolyte and separate collection of acid and base will be constructed. Minimum target concentrations are pH 0 and 14 (1M concentrations of [H⁺] and [OH⁻]). Separately, HCl and NaOH concentrations of up to 5M will be used in solubility testing, as these are readily accessible from existing chlor-alkali reactors. A model for highly concentrated solutions will be developed to guide selection of acids/bases for dissolving industry-sourced ash samples. A solubility model for multiple metals in concentrated solution will be developed. A process for SiO₂ and other alkali-soluble metals at >1M total concentration will be developed. A process for dissolving acid-soluble ash constituents to >1M total concentration will be developed. A process for dissolving 90% of noble metals in representative bottom ash will be developed.

A sequential-precipitation reactor and protocol will be developed that can quantitatively assess efficiency and selectivity of metal salt precipitation from dissolved ash solutions to precision appropriate for targeted recovery of 95% of CMs and 90% of other metals. Precipitation of SiO₂ and other base-soluble/acid-insoluble metals will be characterized. Precipitation of hydroxides of Ca, Mg, and other metals will be characterized. Precipitation of rare earth elements as hydroxides will be characterized. Precipitation of recalcitrant metals as other metal salts will be evaluated.

The efficiency and selectivity of electrowinning various metals from dissolved ash will be experimentally and theoretically evaluated. A sequential electrowinning apparatus will be constructed that is capable of quantifying the efficiency and selectivity of electrowinning dissolved MSWI ash. The effect of three main control variables will be evaluated: additives for surface modification, waveform currents, and simultaneous electrowinning. The effect of additives for surface modification will be studied. The aim will be to modify the surface to suppress hydrogen evolution reaction, enabling high Faradaic efficiency. There may be opportunities to capture hydrogen. The effect of waveform currents will be studied. Pulse or frequency-modulated deposition increases energy efficiency where a pulsating boundary layer can suppress morphological instabilities. Phase-field modeling and experiments will be used to analyze the effect of waveforms on electrodeposition of base-metals, low-concentration metals and platinum group metals (PGMs). The effect of simultaneous electrowinning will be studied. First-principles modeling and experiments will be used to evaluate the electrowinning of mixed metals simultaneously present at low and high concentration. Electrode potential gives control to achieve this goal. Electrorefining to separate metals with similar reduction potentials will be evaluated using both computational modeling and experimental testing.

Cost analysis was performed for a plant which in 2019 burned 177,040 tons of MSW, generating 105,000 MWh of electricity and producing 42,598 tons of ash (and 4802 tons of recovered postburn metal). 15% of electricity production was used for internal operations. Assuming the remaining 85% was sold at a PPA price of $0.05/kWh and the ash was landfilled at cost of ˜$50 per ton, the net revenue was $2.33 MM, or $0.055 per kg of ash produced. This analysis used the simplifying assumption that the future cost of distribution and sales of recycled ash product will incur a cost equal to the current ash disposal cost of 50/ton.

The theoretically achievable value in recovering elements from ash is substantial. FIG. 3A shows the elemental makeup of MSWI ash from several worldwide sources, which when scaled by elemental price, yields cumulative value for ash compositions reported in literature that ranges from ˜$0.30 to as much as ˜$2.75 per kg ash, see FIG. 3B. Note that over 90% of the value in each ash comes from the first five most abundant elements.

The cost of extraction was estimated as follows. The cost of a water electrolysis facility that produces enough moles of acid to dissolve and precipitate 43 ktons of ash per year is ˜$6.4 MM. This estimate is based on published cost information for large scale water electrolysis. The assumed electrolyzer capex is $900/MW and operating efficiency is 52 kWh/kg H₂. Note that each mole of H₂ produced by the electrolyser produces two moles of base and four moles of acid (FIG. 4B). Operation at 95% capacity factor was assumed, in parallel with data for MSWI incinerators. The ash composition was taken to be an average of those shown in FIG. 3A. A total plant capex about three times that of the electrolyzer facility was estimated, or $20 MM, and straight-line depreciation over 7 years was assumed (incurring depreciation cost of $2.9 MM/year). It was further assumed that all of the electricity produced is used for extraction and recovery, with zero revenue from electricity sales, which adds cost of $2.13 MM (calculated at $0.05/kWh) to the cost of extraction and recovery. The net cost to process 43 ktons ash per year is then 0.12/kg ash, which is comfortably below the embodied ash value of $0.30-$2.75/kg. This initial analysis suggests a meaningful value proposition. For a plant of the scale modeled here, ash sales of 0.50/kg would generate net revenue 7.7 times those realizable from electricity sales; ash sales of $1/kg would generate 12 times the electricity revenue. Reduced natural gas consumption due to supplementation by co-produced hydrogen, or reduced lime consumption due to recapture, would further reduce the cost to operate the WTE facility and enhance the value proposition.

### Example 2

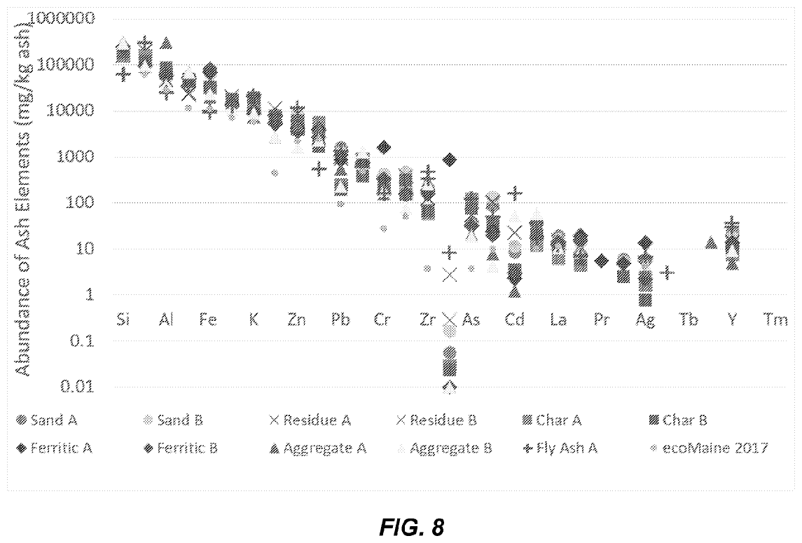

This example describes a process for electrochemical processing of MSWI ash. Said ash was separated into various fractions and chemical analysis was performed on each fraction using inductively-coupled plasma emission (ICP) spectroscopy, producing the compositional analysis of each separated fraction of the ash as shown in FIG. 8. Of these fractions, the one labeled “Sand A” was selected for electrochemical processing by the following procedures. 10 g of ash was added into 100 mL of 1M HCl, and held for 24 hrs at 25° C. without stirring in order to leach the ash. The insoluble portion of the ash was then separated from the acid leachate using vacuum filtration.

The acid leachate was then analysed by ICP. The concentrations of various elements detected in the ash are shown below in Table 1, in units of weight ppm and in units of millimolar concentration.

TABLE 1
ICP Analysis of Acid Leachate

| | Ag | Al | B | Ba | Bi | Ca | Cd | Co | Cr | Cu | Fe | Ga |
|---|---|---|---|---|---|---|---|---|---|---|---|---|
| ppm | 27.7 | 3909.4 | 22.1 | 3.3 | 4.2 | 13250.1 | 2.2 | 12.8 | 6.7 | 82.6 | 3085.6 | 14.7 |
| mMol | 0.26 | 144.90 | 2.04 | 0.02 | 0.02 | 331.25 | 0.02 | 0.46 | 0.13 | 1.30 | 55.30 | 0.21 |

| | In | K | Li | Mg | Mn | Na | Ni | Pb | Sr | Tl | Zn |
|---|---|---|---|---|---|---|---|---|---|---|---|
| ppm | 25.9 | 369.2 | 66.63 | 1421.1 | 86.2 | 596.58 | 12.3 | 108.7 | 30.5 | 52.3 | 566.8 |
| mMol | 0.23 | 9.44 | 16.00 | 58.47 | 1.57 | 43.25 | 0.21 | 0.52 | 0.35 | 0.26 | 8.67 |

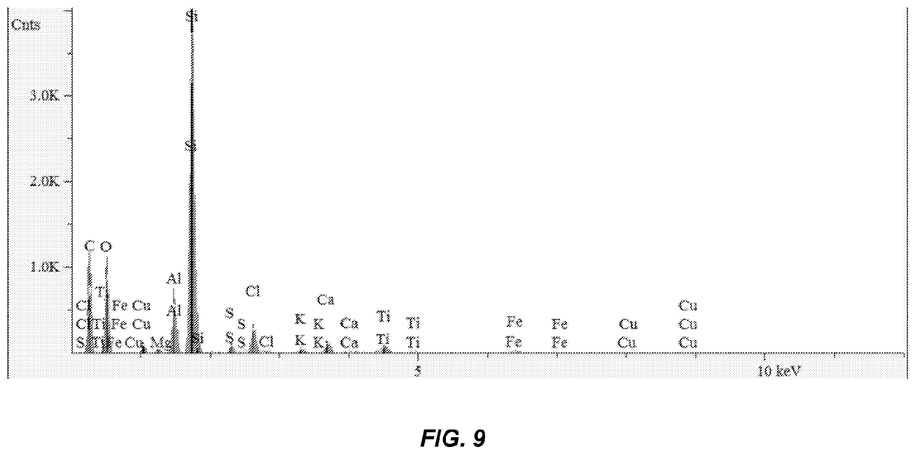

The insoluble portion of the ash was dried after filtration, and analysed in a secondary electron microscope (SEM) equipped with an energy-dispersive X-ray detector (EDS). A representative EDS spectrum of the insoluble portion of the ash is shown in FIG. 9, and the corresponding composition is shown below in Table 2.

TABLE 2
Composition of Insoluble Portion of Ash

| Element | Atomic % | Weight % |
|---|---|---|
| O | 63.5 | 48.5 |
| Na | 1.3 | 1.5 |
| Mg | 0.6 | 0.7 |
| Al | 4.1 | 5.2 |
| Si | 24.8 | 33.3 |
| S | 0.7 | 1.1 |
| Cl | 2.1 | 3.5 |
| K | 0.5 | 1.0 |
| Ca | 0.9 | 1.7 |
| Ti | 0.9 | 2.0 |
| Fe | 0.5 | 1.2 |
| Cu | 0.1 | 0.4 |

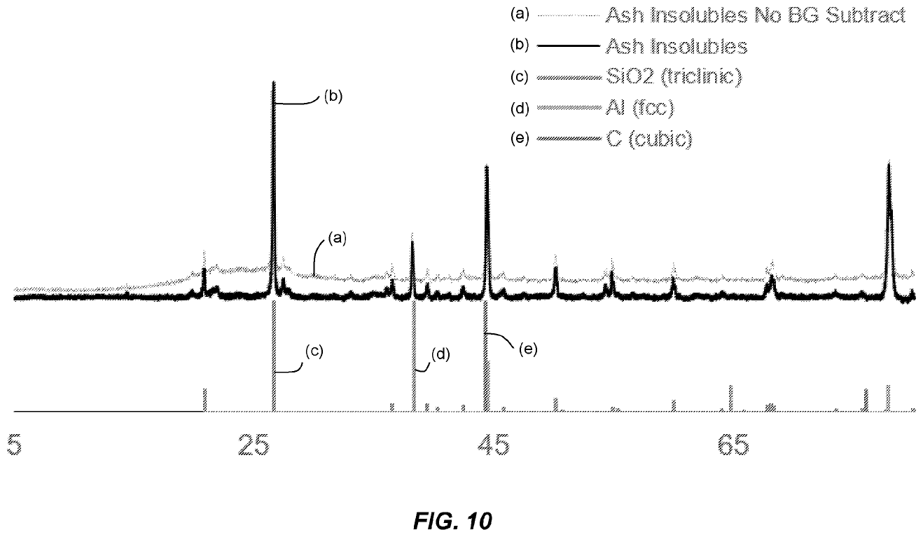

Amongst the elements detected, it was found that 81.7% by weight of the leached ash comprised Si and O, while 18.3 wt. % comprised elements other than Si and O. An X-ray diffraction analysis was performed on the insoluble portion of the leached ash, the diffraction pattern from which is shown in FIG. 10. This analysis showed that aside from some aluminum (which was a part of the sample holder and not the ash sample), the only crystalline phase detected was crystalline SiO₂. Moreover, it was found that of the SiO₂ present in the sample, 10% was crystalline and 90% was amorphous. It is noted that amorphous silica is a preferred form of silica for use in cement formulations, in some embodiments.

Precipitation experiments were conducted on a portion of the acid leachate using the following procedures. 5 mL of acid leachate was held at 25° C. without stirring. 0.01M, 1M, or 10M NaOH was added dropwise to the solution to reach a target pH, measured by a pH sensor. The precipitation reaction was allowed to occur over 24 hours. The precipitate was separated from the remaining solution using vacuum filtration, rinsed with deionized water, and dried. The remaining solution was then raised in pH to the next target pH, held for 24 hours, and the newly precipitated solid at said target pH was collected by vacuum filtration, rinsed with deionized water, and dried. This procedure was repeated.

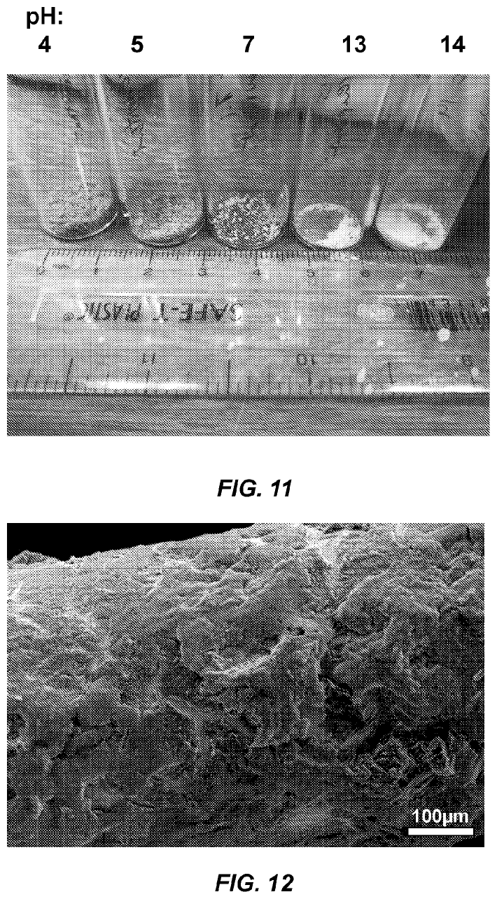

The precipitates obtained through this process of sequential precipitation at successively higher pH values of 4, 5, 7, 13 and 14 are shown in FIG. 11. Each of these precipitates was re-dissolved in 10 mL of a 5% HNO₃ solution, and analysed by ICP to determine the composition of the precipitate. It was seen that with increasing pH, the highest concentration elements in the precipitate changed from Fe and Al to include Zn and Ca, and at the highest pH values of 13 and 14, it was primarily Ca. Thus, this demonstrated the capability of the described process to selectively precipitate elements.

A portion of the acid leachate was then used for materials recovery via electrowinning. 15 mL of acid leachate was held in a glass beaker held at 60° C. in a water bath, and stirred at 200 rpm with a magnetic stir bar. Platinum wire was used as both the working and counter electrode. Electrowinning was conducted at a fixed potential versus an Ag/AgCl reference, for a period of 1 hr at each potential setting. The electrodes were then removed, rinsed in DI water, and dried for subsequent analysis.

An example of a metal deposit recovered by electrowinning at −0.75V vs an Ag/AgCl reference electrode is shown in the SEM image in FIG. 12. After electrowinning at each selected potential, the deposit was removed from the platinum wire by dissolution in 10 mL of a 5% HNO₃ solution, and analysed by ICP. The composition of the electrowon elements at each of five potentials from −0.5 V to −1.25 V (−0.5 V, −0.75 V, −0.9 V, −1.1 V, and −1.25 V) vs an Ag/AgCl reference are shown in Table 3.

TABLE 3
Composition of Electrowon Elements at Various Potentials

| Potential (vs Ag/AgCl) | Cu | Fe | Ni | Pb | Zn | Other |
|---|---|---|---|---|---|---|
| −0.5 V | 67% | <1% | <1% | <1% | <1% | 33% |
| −0.75 V | 49% | <1% | <1% | 38% | <1% | 13% |
| −0.9 V | 53% | <1% | <1% | 27% | <1% | 19% |
| −1.1 V | 30% | 5% | 5% | 26% | 27% | 6% |
| −1.25 V | 3% | 6% | 1% | 4% | 86% | <1% |

It was seen that with increasingly negative potential, the makeup of the electrowon metals varied. The metals in highest concentration varied from Cu, to Cu and Pb, to Cu, Pb, Ni and Zn, to mostly Zn with some Ni, with increasingly negative potential. Thus, this demonstrated the ability of the process to selectively electrowin elements from the acid leachate of the ash.

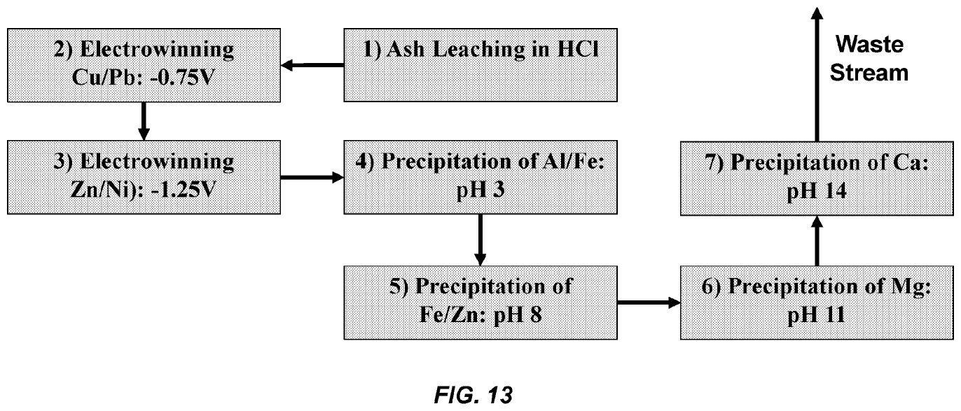

Based on the experiments in this Example, a non-limiting example of a suitable order-of-operations for recovery of elements from the ash in certain embodiments was established, as shown in FIG. 13. First, the ash may be leached with acid (e.g., HCl). Then, the acid leachate may be subject to electrowinning at −0.75 V vs Ag/AgCl, to recover Cu and Pb. Then, the remaining acid leachate may be electrowon at −1.25V vs Ag/AgCl to recover Zn and Ni. Then, the remaining acid leachate may be subjected to precipitation sequentially at pH=3 to recover Al and Fe, at pH=8 to recover Fe and Zn (the proportion of Zn which has not already been electrowon), at pH=11 to recover Mg, and finally at pH=14 to recover Ca.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present invention.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method, comprising dissolving at least a portion of ash in acid to produce refined silica with a purity of greater than or equal to 60 wt. %.

2. The method of claim 1, wherein the refined silica has a purity of greater than or equal to 80 wt. %.

3. The method of any preceding claim, wherein the refined silica has a purity of greater than or equal to 90 wt. %.

4. The method of any preceding claim, wherein the refined silica has a purity of less than or equal to 99.9 wt. %.

5. The method of any preceding claim, wherein the refined silica comprises less than or equal to 2 wt. % toxic impurities.

6. The method of claim 5, wherein the toxic impurities comprise mercury, lead, cadmium, chromium, and/or arsenic.

7. The method of any preceding claim, wherein the dissolving at least a portion of ash in acid produces greater than or equal to 10 kg of refined silica.

8. The method of any preceding claim, wherein the dissolving at least a portion of ash in acid produces less than or equal to 1,000,000 kg of refined silica.

9. The method of any preceding claim, wherein the refined silica comprises greater than or equal to 10 wt. % amorphous silica.

10. The method of any preceding claim, wherein the refined silica comprises less than or equal to 95 wt. % amorphous silica.

11. The method of any preceding claim, wherein the refined silica comprises greater than or equal to 40 wt. % amorphous silica.

12. The method of any preceding claim, wherein the refined silica comprises greater than or equal to 80 wt. % amorphous silica.

13. The method of any preceding claim, wherein the method further comprises disposing the refined silica in a landfill; using the refined silica as a component in cement, concrete, and/or construction materials; using the refined silica to make glass; and/or using the refined silica as a dessicant, thickener, and/or additive in rubber and/or plastics.

14. The method of any preceding claim, wherein the dissolving at least a portion of ash in acid produces the refined silica and an acid leachate, and wherein the method further comprises at least partially separating the refined silica from the acid leachate.

15. The method of claim 14, wherein the method further comprises electrowinning the acid leachate to produce one or more electroplated metals.

16. The method of claim 15, wherein the one or more electroplated metals comprises a metal that was present in an amount of less than or equal to 10 wt. % of the ash.

17. The method of any one of claims 15-16, wherein the one or more electroplated metals comprises a metal that was present in an amount of less than or equal 1 wt. % of the ash.

18. The method of any one of claims 15-17, wherein the one or more electroplated metals comprises a metal that was present in an amount of greater than or equal to 1 part per billion (ppb) of the ash.

19. The method of any one of claims 15-18, wherein the one or more electroplated metals comprises Mn, Zn, Cr, Fe, Cd, Co, Ni, Pb, Cu, Bi, As, Ag, and/or Hg.

20. The method of any one of claims 15-19, wherein the electrowinning the acid leachate produces at least two electroplated metals, and wherein the method further comprises electrorefining the at least two electroplated metals to at least partially separate at least one electroplated metal from the other.

21. The method of any one of claims 15-20, wherein the electrowinning and/or electrorefining comprises the use of porous electrodes.

22. The method of any one of claims 15-21, wherein the electrowinning and/or electrorefining comprises the use of a flow-by apparatus.

23. The method of any one of claims 15-21, wherein the electrowinning and/or electrorefining comprises the use of a flow-through apparatus.

24. The method of any one of claims 15-23, wherein the electrowinning the acid leachate further produces an aqueous solution, and wherein the method further comprises adding a base to the aqueous solution to precipitate one or more metal hydroxides.

25. The method of claim 24, wherein the one or more metal hydroxides comprises calcium hydroxide, magnesium hydroxide, strontium hydroxide, barium hydroxide, manganese hydroxide, iron oxide, cobalt hydroxide, nickel hydroxide, zinc hydroxide, zirconium hydroxide, cerium hydroxide, vanadium hydroxide, neodymium hydroxide, dysprosium hydroxide, cadmium hydroxide, lead hydroxide, silicon hydroxide, and/or aluminum hydroxide.

26. The method of any preceding claim, wherein the method further comprises adding a base to the refined silica to form a basic solution and a solid, at least partially separating the solid from the basic solution to form a separated basic solution, adding an acid to the separated basic solution to form an acidic solution, and electrowinning the acidic solution to produce one or more electroplated noble metals.

27. The method of claim 26, wherein the one or more electroplated noble metals comprises gold, silver, platinum, palladium, rhodium, and/or iridium.

28. The method of any one of claims 26-27, wherein the electrowinning the acidic solution produces at least two electroplated noble metals, and wherein the method further comprises electrorefining the at least two electroplated noble metals to separate at least one electroplated noble metal from the other.

29. The method of any one of claims 24-28, wherein the base is produced in a reactor.

30. The method of any preceding claim, wherein the acid is produced in a reactor.
